(19) United States
(12) Patent Application Publication
(10) Pub. No.: US 2026/0129655 A1
(43) Pub. Date: May 7, 2026

(54) SKIPPING MEASUREMENT GAPS

(71) Applicant: QUALCOMM Incorporated, San Diego, CA (US)

(72) Inventors: Hyun Yong LEE, San Diego, CA (US); Linhai HE, San Diego, CA (US); Huilin XU, Beijing (CN); Prashanth Haridas HANDE, San Diego, CA (US); Peerapol TINNAKORNSRISUPHAP, San Diego, CA (US); Prashant SHARMA, San Marcos, CA (US); Jae Ho RYU, San Diego, CA (US); Sitaramanjaneyulu KANAMARLAPUDI, San Diego, CA (US); Diana MAAMARI, San Diego, CA (US)

(21) Appl. No.: 19/367,662

(22) Filed: Oct. 23, 2025

Related U.S. Application Data
(60) Provisional application No. 63/717,744, filed on Nov. 7, 2024.

(51) Int. Cl. H04W 72/232; H04W 36/00; H04W 72/1263

(52) U.S. Cl. CPC H04W 72/232; H04W 36/0085; H04W 72/1263

(57) ABSTRACT

Various aspects of the present disclosure generally relate to wireless communication. In some aspects, a user equipment (UE) may receive downlink control information comprising a first indication of whether the UE is to skip a first measurement gap and a second indication of whether the UE is to skip a second measurement gap. The UE may selectively skip the first measurement gap based at least in part on the first indication in the downlink control information. The UE may selectively skip the second measurement gap based at least in part on the second indication in the downlink control information. Numerous other aspects are described.

### CROSS-REFERENCE TO RELATED APPLICATION

This Patent Application claims priority to U.S. Provisional Patent Application No. 63/717,744, filed on Nov. 7, 2024, entitled “SKIPPING MEASUREMENT GAPS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with skipping measurement gaps.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving downlink control information (DCI) comprising a first indication of whether the UE is to skip a first measurement gap and a second indication of whether the UE is to skip a second measurement gap. The method may include selectively skipping the first measurement gap based at least in part on the first indication in the DCI. The method may include selectively skipping the second measurement gap based at least in part on the second indication in the DCI.

Some aspects described herein relate to a method of wireless communication performed by a UE. The method may include receiving signaling indicating a pattern of valid measurement gap occurrences and skipped measurement gap occurrences. The method may include measuring a neighbor cell signal strength during the valid measurement gap occurrences indicated by the pattern. The method may include skipping measurement gaps that correspond to the skipped measurement gap occurrences indicated by the pattern.

Some aspects described herein relate to a method of wireless communication performed by a UE. The method may include receiving signaling indicating for the UE to skip measurement gaps that overlap in a time domain with a discontinuous reception (DRX) active duration of the UE. The method may include identifying one or more measurement gaps that overlap in the time domain with the DRX active duration of the UE. The method may include skipping the one or more measurement gaps based at least in part on the one or more measurement gaps overlapping in the time domain with the DRX active duration of the UE.

Some aspects described herein relate to a method of wireless communication performed by a UE. The method may include receiving DCI comprising an indication of whether the UE is to skip a measurement gap corresponding to a next measurement gap occurrence that overlaps in time with a DRX active duration of the UE. The method may include switching from a DRX active state to a DRX inactive state for a DRX inactive duration, wherein the DRX inactive duration of the UE overlaps in time with one or more measurement gaps. The method may include switching from the DRX inactive state to the DRX active state after the DRX inactive duration. The method may include selectively skipping the measurement gap based at least in part on the measurement gap corresponding to the next measurement gap occurrence that overlaps in time with the DRX active duration of the UE.

Some aspects described herein relate to a method of wireless communication performed by a UE. The method may include measuring, during a DRX active duration of the UE, a neighbor cell signal strength during a measurement gap. The method may include adjusting one or more parameters associated with a DRX cycle of the UE based at least in part on an overlap in time between the DRX active duration of the UE and the measurement gap. The method may include extending the DRX active duration of the UE for the DRX cycle in accordance with the adjusting.

Some aspects described herein relate to a method of wireless communication performed by a network node. The method may include transmitting, to a UE, first DCI comprising a first indication for the UE to skip a first measurement gap corresponding to a next measurement gap occurrence. The method may include transmitting, based at least in part on determining that a next DRX active state of the UE overlaps in time with a second measurement gap that occurs after the next measurement gap occurrence, a signal without data or a signal with dummy data to the UE via a physical downlink shared channel (PDSCH). The method may include transmitting, to the UE after a beginning of the first measurement gap, second DCI comprising a second indication for the UE to skip the second measurement gap, wherein the second measurement gap corresponds to the next measurement gap occurrence.

Some aspects described herein relate to an apparatus for wireless communication at a UE. The apparatus may include one or more memories and one or more processors coupled to the one or more memories. The one or more processors may be configured to receive DCI comprising a first indication of whether the UE is to skip a first measurement gap and a second indication of whether the UE is to skip a second measurement gap. The one or more processors may be configured to selectively skip the first measurement gap based at least in part on the first indication in the DCI. The one or more processors may be configured to selectively skip the second measurement gap based at least in part on the second indication in the DCI.

Some aspects described herein relate to an apparatus for wireless communication at a UE. The apparatus may include one or more memories and one or more processors coupled to the one or more memories. The one or more processors may be configured to receive signaling indicating a pattern of valid measurement gap occurrences and skipped measurement gap occurrences. The one or more processors may be configured to measure a neighbor cell signal strength during the valid measurement gap occurrences indicated by the pattern. The one or more processors may be configured to skip measurement gaps that correspond to the skipped measurement gap occurrences indicated by the pattern.

Some aspects described herein relate to an apparatus for wireless communication at a UE. The apparatus may include one or more memories and one or more processors coupled to the one or more memories. The one or more processors may be configured to receive signaling indicating for the UE to skip measurement gaps that overlap in a time domain with a DRX active duration of the UE. The one or more processors may be configured to identify one or more measurement gaps that overlap in the time domain with the DRX active duration of the UE. The one or more processors may be configured to skip the one or more measurement gaps based at least in part on the one or more measurement gaps overlapping in the time domain with the DRX active duration of the UE.

Some aspects described herein relate to an apparatus for wireless communication at a UE. The apparatus may include one or more memories and one or more processors coupled to the one or more memories. The one or more processors may be configured to receive DCI comprising an indication of whether the UE is to skip a measurement gap corresponding to a next measurement gap occurrence that overlaps in time with a DRX active duration of the UE. The one or more processors may be configured to switch from a DRX active state to a DRX inactive state for a DRX inactive duration, wherein the DRX inactive duration of the UE overlaps in time with one or more measurement gaps. The one or more processors may be configured to switch from the DRX inactive state to the DRX active state after the DRX inactive duration. The one or more processors may be configured to selectively skip the measurement gap based at least in part on the measurement gap corresponding to the next measurement gap occurrence that overlaps in time with the DRX active duration of the UE.

Some aspects described herein relate to an apparatus for wireless communication at a UE. The apparatus may include one or more memories and one or more processors coupled to the one or more memories. The one or more processors may be configured to measure, during a DRX active duration of the UE, a neighbor cell signal strength during a measurement gap. The one or more processors may be configured to adjust one or more parameters associated with a DRX cycle of the UE based at least in part on an overlap in time between the DRX active duration of the UE and the measurement gap. The one or more processors may be configured to extend the DRX active duration of the UE for the DRX cycle in accordance with the adjusting.

Some aspects described herein relate to an apparatus for wireless communication at a network node. The apparatus may include one or more memories and one or more processors coupled to the one or more memories. The one or more processors may be configured to transmit, to a UE, first DCI comprising a first indication for the UE to skip a first measurement gap corresponding to a next measurement gap occurrence. The one or more processors may be configured to transmit, based at least in part on determining that a next DRX active state of the UE overlaps in time with a second measurement gap that occurs after the next measurement gap occurrence, a signal without data or a signal with dummy data to the UE via a PDSCH. The one or more processors may be configured to transmit, to the UE after a beginning of the first measurement gap, second DCI comprising a second indication for the UE to skip the second measurement gap, wherein the second measurement gap corresponds to the next measurement gap occurrence.

Some aspects described herein relate to a non-transitory computer-readable medium that stores a set of instructions for wireless communication by a UE. The set of instructions, when executed by one or more processors of the UE, may cause the UE to receive DCI comprising a first indication of whether the UE is to skip a first measurement gap and a second indication of whether the UE is to skip a second measurement gap. The set of instructions, when executed by one or more processors of the UE, may cause the UE to selectively skip the first measurement gap based at least in part on the first indication in the DCI. The set of instructions, when executed by one or more processors of the UE, may cause the UE to selectively skip the second measurement gap based at least in part on the second indication in the DCI.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to receive signaling indicating a pattern of valid measurement gap occurrences and skipped measurement gap occurrences. The set of instructions, when executed by one or more processors of the one or more instructions that, when executed by one or more processors of a UE, may cause the one or more instructions that, when executed by one or more processors of a UE to measure a neighbor cell signal strength during the valid measurement gap occurrences indicated by the pattern. The set of instructions, when executed by one or more processors of the one or more instructions that, when executed by one or more processors of a UE, may cause the one or more instructions that, when executed by one or more processors of a UE to skip measurement gaps that correspond to the skipped measurement gap occurrences indicated by the pattern.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to receive signaling indicating for the UE to skip measurement gaps that overlap in a time domain with a DRX active duration of the UE. The set of instructions, when executed by one or more processors of the one or more instructions that, when executed by one or more processors of a UE, may cause the one or more instructions that, when executed by one or more processors of a UE to identify one or more measurement gaps that overlap in the time domain with the DRX active duration of the UE. The set of instructions, when executed by one or more processors of the one or more instructions that, when executed by one or more processors of a UE, may cause the one or more instructions that, when executed by one or more processors of a UE to skip the one or more measurement gaps based at least in part on the one or more measurement gaps overlapping in the time domain with the DRX active duration of the UE.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to receive DCI comprising an indication of whether the UE is to skip a measurement gap corresponding to a next measurement gap occurrence that overlaps in time with a DRX active duration of the UE. The set of instructions, when executed by one or more processors of the one or more instructions that, when executed by one or more processors of a UE, may cause the one or more instructions that, when executed by one or more processors of a UE to switch from a DRX active state to a DRX inactive state for a DRX inactive duration, wherein the DRX inactive duration of the UE overlaps in time with one or more measurement gaps. The set of instructions, when executed by one or more processors of the one or more instructions that, when executed by one or more processors of a UE, may cause the one or more instructions that, when executed by one or more processors of a UE to switch from the DRX inactive state to the DRX active state after the DRX inactive duration. The set of instructions, when executed by one or more processors of the one or more instructions that, when executed by one or more processors of a UE, may cause the one or more instructions that, when executed by one or more processors of a UE to selectively skip the measurement gap based at least in part on the measurement gap corresponding to the next measurement gap occurrence that overlaps in time with the DRX active duration of the UE.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to measure, during a DRX active duration of the UE, a neighbor cell signal strength during a measurement gap. The set of instructions, when executed by one or more processors of the one or more instructions that, when executed by one or more processors of a UE, may cause the one or more instructions that, when executed by one or more processors of a UE to adjust one or more parameters associated with a DRX cycle of the UE based at least in part on an overlap in time between the DRX active duration of the UE and the measurement gap. The set of instructions, when executed by one or more processors of the one or more instructions that, when executed by one or more processors of a UE, may cause the one or more instructions that, when executed by one or more processors of a UE to extend the DRX active duration of the UE for the DRX cycle in accordance with the adjusting.

Some aspects described herein relate to a non-transitory computer-readable medium that stores a set of instructions for wireless communication by a network node. The set of instructions, when executed by one or more processors of the network node, may cause the network node to transmit, to a UE, first DCI comprising a first indication for the UE to skip a first measurement gap corresponding to a next measurement gap occurrence. The set of instructions, when executed by one or more processors of the network node, may cause the network node to transmit, based at least in part on determining that a next DRX active state of the UE overlaps in time with a second measurement gap that occurs after the next measurement gap occurrence, a signal without data or a signal with dummy data to the UE via a PDSCH. The set of instructions, when executed by one or more processors of the network node, may cause the network node to transmit, to the UE after a beginning of the first measurement gap, second DCI comprising a second indication for the UE to skip the second measurement gap, wherein the second measurement gap corresponds to the next measurement gap occurrence.

Some aspects described herein relate to an apparatus for wireless communication. The apparatus may include means for receiving DCI comprising a first indication of whether the UE is to skip a first measurement gap and a second indication of whether the UE is to skip a second measurement gap. The apparatus may include means for selectively skipping the first measurement gap based at least in part on the first indication in the DCI. The apparatus may include means for selectively skipping the second measurement gap based at least in part on the second indication in the DCI.

Some aspects described herein relate to an apparatus for wireless communication. The apparatus may include means for receiving signaling indicating a pattern of valid measurement gap occurrences and skipped measurement gap occurrences. The apparatus may include means for measuring a neighbor cell signal strength during the valid measurement gap occurrences indicated by the pattern. The apparatus may include means for skipping measurement gaps that correspond to the skipped measurement gap occurrences indicated by the pattern.

Some aspects described herein relate to an apparatus for wireless communication. The apparatus may include means for receiving signaling indicating for the UE to skip measurement gaps that overlap in a time domain with a DRX active duration of the UE. The apparatus may include means for identifying one or more measurement gaps that overlap in the time domain with the DRX active duration of the UE. The apparatus may include means for skipping the one or more measurement gaps based at least in part on the one or more measurement gaps overlapping in the time domain with the DRX active duration of the UE.

Some aspects described herein relate to an apparatus for wireless communication. The apparatus may include means for receiving DCI comprising an indication of whether the UE is to skip a measurement gap corresponding to a next measurement gap occurrence that overlaps in time with a DRX active duration of the UE. The apparatus may include means for switching from a DRX active state to a DRX inactive state for a DRX inactive duration, wherein the DRX inactive duration of the UE overlaps in time with one or more measurement gaps. The apparatus may include means for switching from the DRX inactive state to the DRX active state after the DRX inactive duration. The apparatus may include means for selectively skipping the measurement gap based at least in part on the measurement gap corresponding to the next measurement gap occurrence that overlaps in time with the DRX active duration of the UE.

Some aspects described herein relate to an apparatus for wireless communication. The apparatus may include means for measuring, during a DRX active duration of the UE, a neighbor cell signal strength during a measurement gap. The apparatus may include means for adjusting one or more parameters associated with a DRX cycle of the UE based at least in part on an overlap in time between the DRX active duration of the UE and the measurement gap. The apparatus may include means for extending the DRX active duration of the UE for the DRX cycle in accordance with the adjusting.

Some aspects described herein relate to an apparatus for wireless communication. The apparatus may include means for transmitting, to a UE, first DCI comprising a first indication for the UE to skip a first measurement gap corresponding to a next measurement gap occurrence. The apparatus may include means for transmitting, based at least in part on determining that a next DRX active state of the UE overlaps in time with a second measurement gap that occurs after the next measurement gap occurrence, a signal without data or a signal with dummy data to the UE via a PDSCH. The apparatus may include means for transmitting, to the UE after a beginning of the first measurement gap, second DCI comprising a second indication for the UE to skip the second measurement gap, wherein the second measurement gap corresponds to the next measurement gap occurrence.

Aspects of the present disclosure may generally be implemented by or as a method, apparatus, system, computer program product, non-transitory computer-readable medium, UE, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3-6 are diagrams illustrating examples of measurement gap skipping, in accordance with the present disclosure.

FIG. 7 is a diagram illustrating an example of extending an active state of a user equipment (UE) in a discontinuous reception cycle, in accordance with the present disclosure.

FIG. 8 is a diagram illustrating an example of measurement gap skipping, in accordance with the present disclosure.

FIGS. 9-13 are diagrams illustrating example processes performed, for example, at a UE or an apparatus of a UE, in accordance with the present disclosure.

FIG. 14 is a diagram illustrating an example process performed, for example, at a network node or an apparatus of a network node, in accordance with the present disclosure.

FIGS. 15 and 16 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, a user equipment (UE) may sometimes switch to different frequencies to monitor channel quality. For example, a UE may monitor different transmission of different radio access technologies (RATs), which may occur on different frequencies. As such, the UE may perform measurements on the different frequencies by stopping its monitoring on the serving cell and retuning to another frequency during measurement gaps—e.g., periods of time in which the UE is allowed to or expected to tune elements of its receiver to frequencies other than that of the serving cell. In some cases, a measurement gap may be referred to as a search window. During these measurement gaps, the UE may receive a primary synchronization signal (PSS), a secondary synchronization signal (SSS), and cell-specific reference signals (CRS) of other cells to allow the UE to discover those cells and conduct signal strength measurements (e.g., reference signal received power (RSRP) or other measures). In some cases, a network node may configure a measurement gap repetition period (e.g., 20 milliseconds (ms), 40 ms, 80 ms, 160 ms) corresponding to a periodicity of the measurement gap occurrences.

During measurement gaps, the UE may be unable to receive transmissions from a network node associated with the serving cell due to tuning one or more elements of its receiver to frequencies other than that of the serving cell. Therefore, the network node may refrain from communicating with the UE during the measurement gaps. To refrain from communicating with the UE during the measurement gaps, the network node may delay a transmission of one or more communications (e.g., from a time that overlaps with the measurement gap to a time that is after an end of the measurement gap). If the delayed transmission corresponds to latency sensitive communications (e.g., low latency communications, extended reality (XR) communications), the network node may indicate for the UE to skip a next measurement gap occurrence. In particular, the network node may transmit a one-bit indication via downlink control information (DCI) indicating for the UE to skip the next measurement gap occurrence. In response to receiving such an indication, the UE may refrain from turning away from the serving cell to perform any measurements of a neighboring cell during the next measurement gap occurrence, and the network node may avoid delaying the transmission of the latency sensitive communication.

However in some cases, a UE may be in a discontinuous reception (DRX) inactive state prior to a measurement gap that would cause the network node to delay the transmission of a latency sensitive communication. Therefore, the UE would be unable to receive a DCI indicating for the UE to skip the next measurement gap occurrence. Additionally, some types of communications (e.g., XR communications) may also be associated with a periodicity that is unable to be configured to align with the periodicity of measurement gap occurrences. For example, the network node may configure measurement gaps according to an integer periodicity (e.g., 20 ms, 40 ms, 80 ms, 160 ms), while XR communications may be associated with a non-integer periodicity (e.g., 60 frames per second corresponds to 16.666 ms) that does not align with the integer periodicity of the measurement gap occurrences. Accordingly, the measurement gaps may overlap with the latency sensitive communications (such as the XR communications) periodically. Further, in cases where the UE is operating according to a DRX cycle and is cycling between a DRX inactive state and a DRX active state to receive periodic communications that have a non-integer periodicity, the UE may be periodically unable to receive a DCI indicating for the UE to skip the next measurement gap occurrence when it overlaps with a low latency communication. Here, the network node may periodically delay the transmission of the low latency communications to the UE, which may introduce latency into the transmission of the low latency communications, such as the XR communications.

In wireless communication networks described herein, the network node and the UE may employ one or more techniques to prevent the network node from periodically delaying communications (e.g., low latency communications, XR communications) resulting from the communications periodically overlapping with measurement gap occurrences and the UE being in a DRX inactive state prior to the measurement gap (e.g., and being unable to receive a DCI indicating for the UE to skip the measurement gap). For example, the network node may indicate or otherwise configure the UE (e.g., via DCI, via a medium access control-control element (MAC-CE), via radio resource control (RRC) signaling) to skip measurement gaps that overlap transmissions of the communications and occur during a DRX active duration of the UE. In some other examples, the UE may be configured to adjust one or more parameters associated with the DRX cycle of the UE to extend a DRX active duration within a DRX cycle in cases that the measurement gap overlaps with the DRX active duration. In some cases, this may enable the network node to transmit the communications within the same DRX cycle (e.g., during the extended DRX active duration) instead of further delaying the transmission of the communications until a next DRX cycle, which may reduce the latency introduced to transmitting the communications. In another example, the network node may transmit signaling (e.g., comprising dummy data) to prevent the UE from switching from a DRX active state to a DRX inactive state until the network node transmits DCI indicating for the UE to skip the next measurement gap occurrence, which may overlap in time with the communication and a DRX active duration of the UE.

Particular aspects of the subject matter described in this disclosure can be implemented to realize one or more of the following potential advantages. In some examples, the described techniques can be used to decrease a latency of communications and increase a coordination between the UE and the network node.

As described above, wireless communication systems may be deployed to provide various services, which may involve carrying or supporting voice, text, other messaging, video, data, and/or other traffic. Some wireless communications systems may employ multiple-access RATs. The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

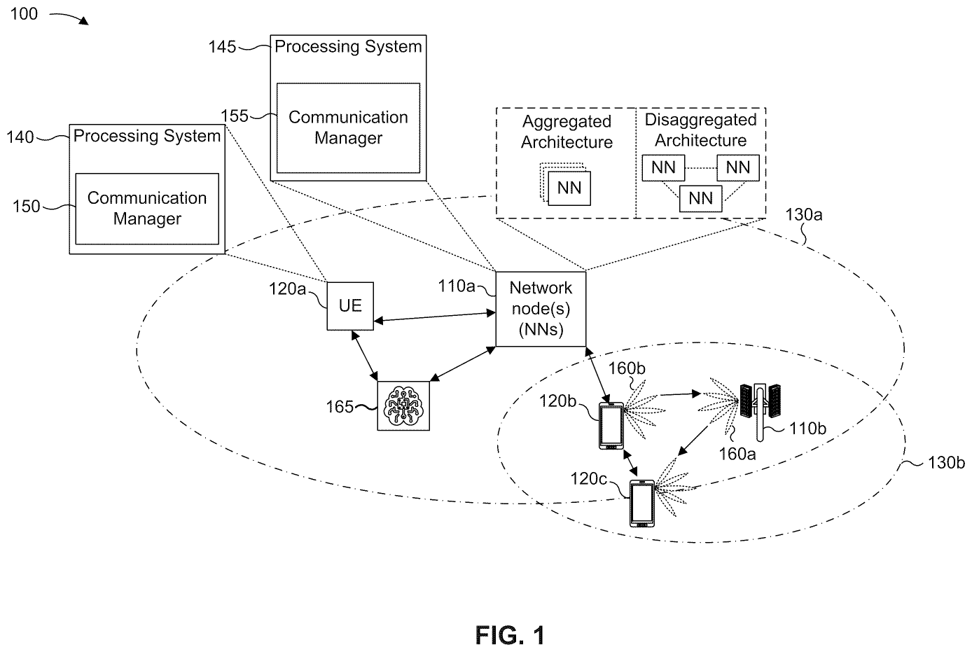

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein.

Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

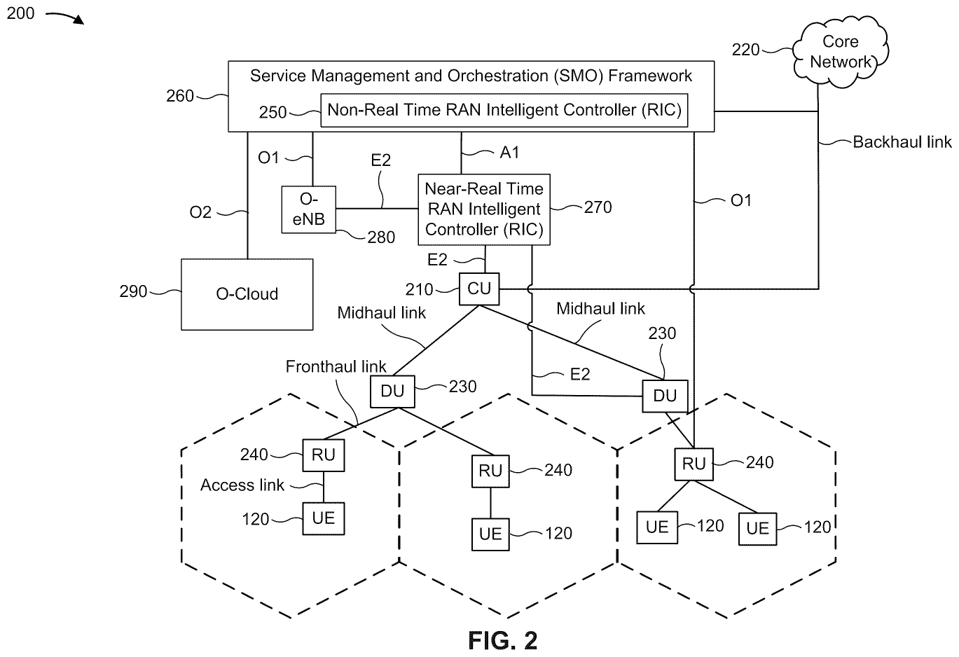

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a PSS, an SSS, a synchronization signal (SS) block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include PDSCHs (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples.

UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Some UEs 120, such as the UE 120a, may support one or more XR functionalities. For example, the UE 120a may be an XR device or may be associated with an XR device (for example, the UE 120a may be connected to the XR device, such as via a wired (for example, universal serial bus (USB), or serial advanced technology attachment (SATA)) connection and/or a wireless (for example, Bluetooth, Wi-Fi, 5G) connection). XR functionalities may include augmented reality (AR), virtual reality (VR), or mixed reality (MR), among other examples. For example, when providing an XR service, the UE 120a may provide rendered data via a display (such as a screen), a set of VR goggles, a heads-up display, or another type of display. The XR device may be an AR glasses device, a VR glass device, or other gaming device.

The XR functionalities may be supported by an application server. The application server may host an application, such as a gaming application, a video streaming application, an XR, VR, or AR application, and/or another type of application for which communication flows of streaming data are provided between a UE 120 and the application server, between an XR device and the application server, and/or between the application server and another device in the wireless communication network 100. The application server may be included in an edge server, a cloud environment, and/or another type of server environment. A UE 120 and/or an XR device may execute an application client associated with the application hosted by the application server, such as a gaming application client, a video streaming application client, an XR application client, a VR application client, an AR application client, and/or another type of application client.

In some aspects, the UE 120 may include a communication manager 150. As described in more detail elsewhere herein, the communication manager 150 may receive DCI comprising a first indication of whether the UE is to skip a first measurement gap and a second indication of whether the UE is to skip a second measurement gap;

selectively skip the first measurement gap based at least in part on the first indication in the DCI; and selectively skip the second measurement gap based at least in part on the second indication in the DCI. Additionally, or alternatively, the communication manager 150 may perform one or more other operations described herein.

As described in more detail elsewhere herein, the communication manager 150 may receive signaling indicating a pattern of valid measurement gap occurrences and skipped measurement gap occurrences; measure a neighbor cell signal strength during the valid measurement gap occurrences indicated by the pattern; and skip measurement gaps that correspond to the skipped measurement gap occurrences indicated by the pattern. Additionally, or alternatively, the communication manager 150 may perform one or more other operations described herein.

As described in more detail elsewhere herein, the communication manager 150 may receive signaling indicating for the UE to skip measurement gaps that overlap in a time domain with a DRX active duration of the UE; identify one or more measurement gaps that overlap in the time domain with the DRX active duration of the UE; and skip the one or more measurement gaps based at least in part on the one or more measurement gaps overlapping in the time domain with the DRX active duration of the UE. Additionally, or alternatively, the communication manager 150 may perform one or more other operations described herein.

As described in more detail elsewhere herein, the communication manager 150 may receive DCI comprising an indication of whether the UE is to skip a measurement gap corresponding to a next measurement gap occurrence that overlaps in time with a DRX active duration of the UE; switch from a DRX active state to a DRX inactive state for a DRX inactive duration, wherein the DRX inactive duration of the UE overlaps in time with one or more measurement gaps; switch from the DRX inactive state to the DRX active state after the DRX inactive duration; and selectively skip the measurement gap based at least in part on the measurement gap corresponding to the next measurement gap occurrence that overlaps in time with the DRX active duration of the UE. Additionally, or alternatively, the communication manager 150 may perform one or more other operations described herein.

As described in more detail elsewhere herein, the communication manager 150 may measure, during a DRX active duration of the UE, a neighbor cell signal strength during a measurement gap; adjust one or more parameters associated with a DRX cycle of the UE based at least in part on an overlap in time between the DRX active duration of the UE and the measurement gap; and extend the DRX active duration of the UE for the DRX cycle in accordance with the adjusting. Additionally, or alternatively, the communication manager 150 may perform one or more other operations described herein.

In some aspects, the network node 110 may include a communication manager 155. As described in more detail elsewhere herein, the communication manager 155 may transmit, to a UE, first DCI comprising a first indication for the UE to skip a first measurement gap corresponding to a next measurement gap occurrence; transmit, based at least in part on determining that a next DRX active state of the UE overlaps in time with a second measurement gap that occurs after the next measurement gap occurrence, a signal without data or a signal with dummy data to the UE via a PDSCH; and transmit, to the UE after a beginning of the first measurement gap, second DCI comprising a second indication for the UE to skip the second measurement gap, wherein the second measurement gap corresponds to the next measurement gap occurrence. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

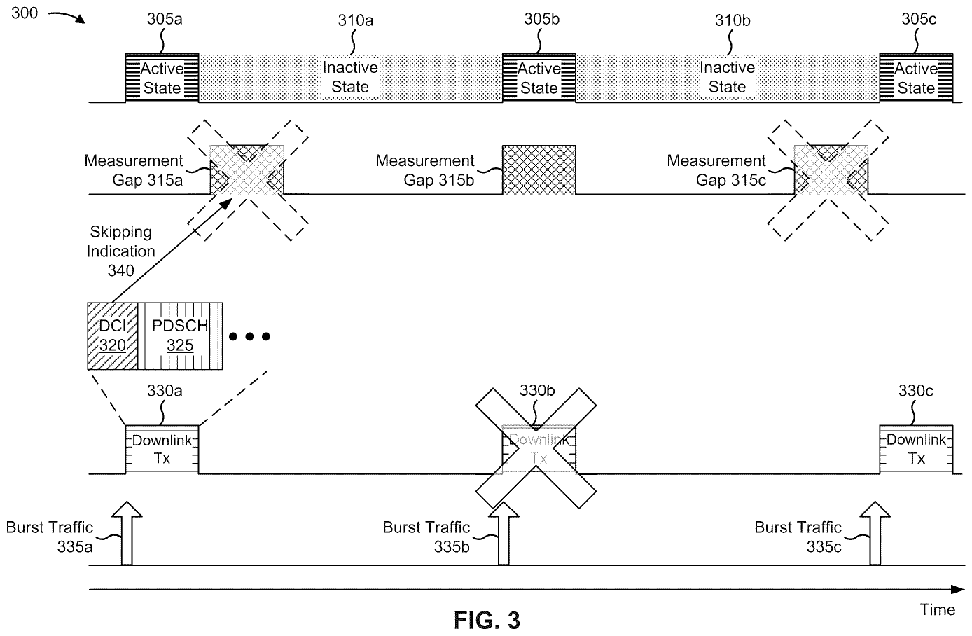

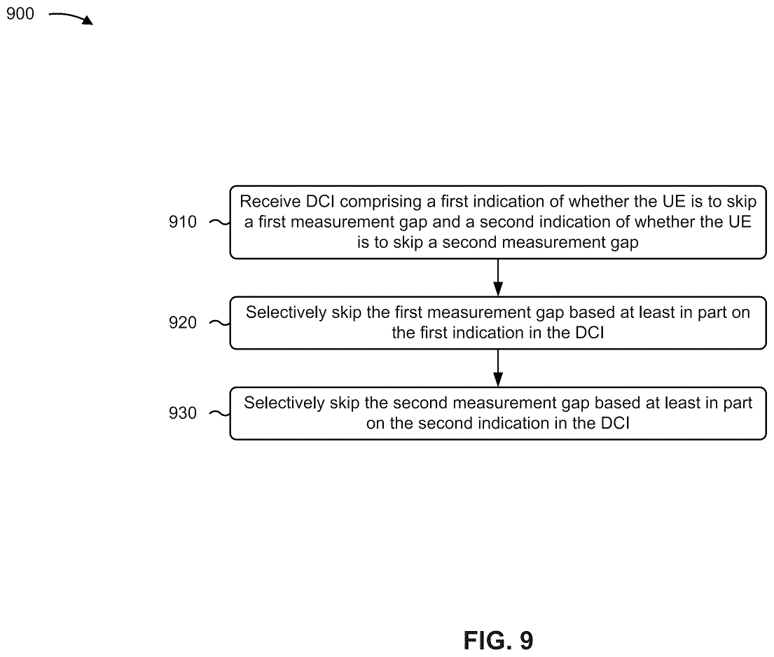

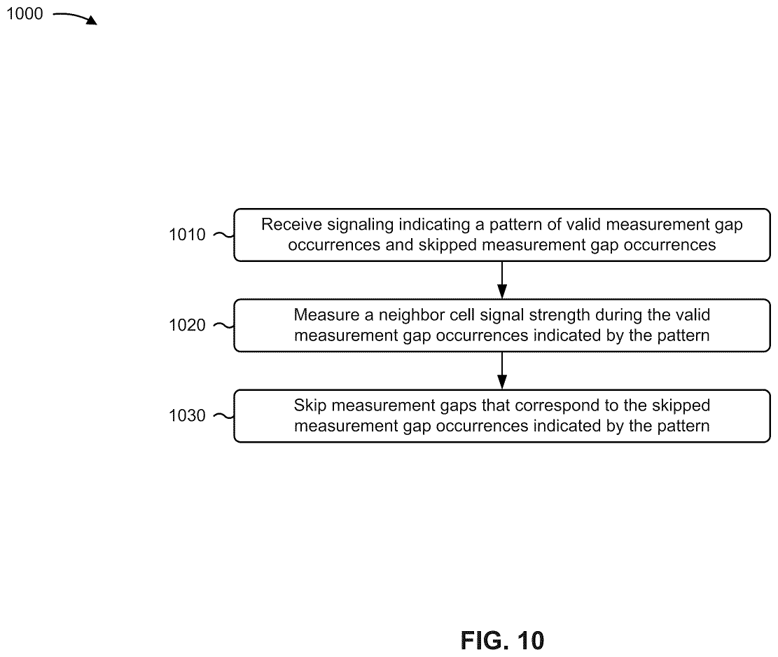

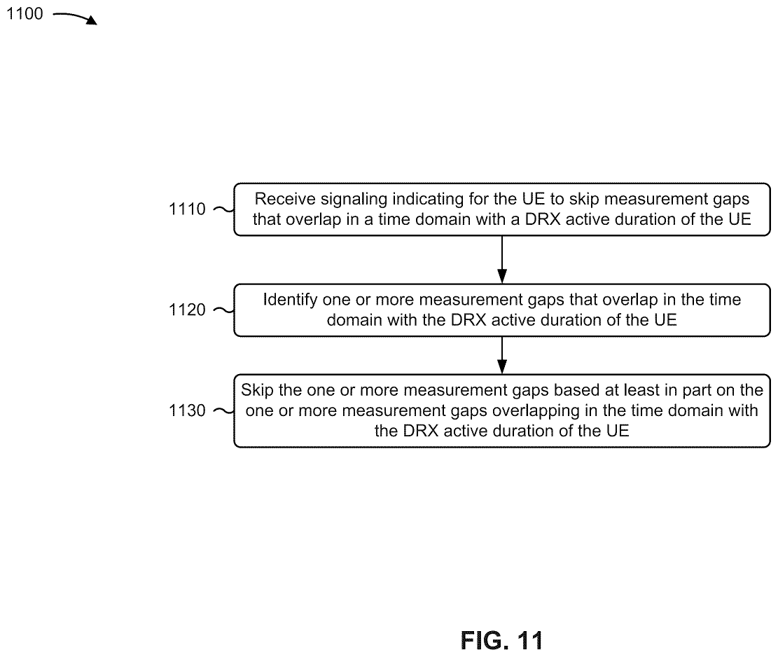

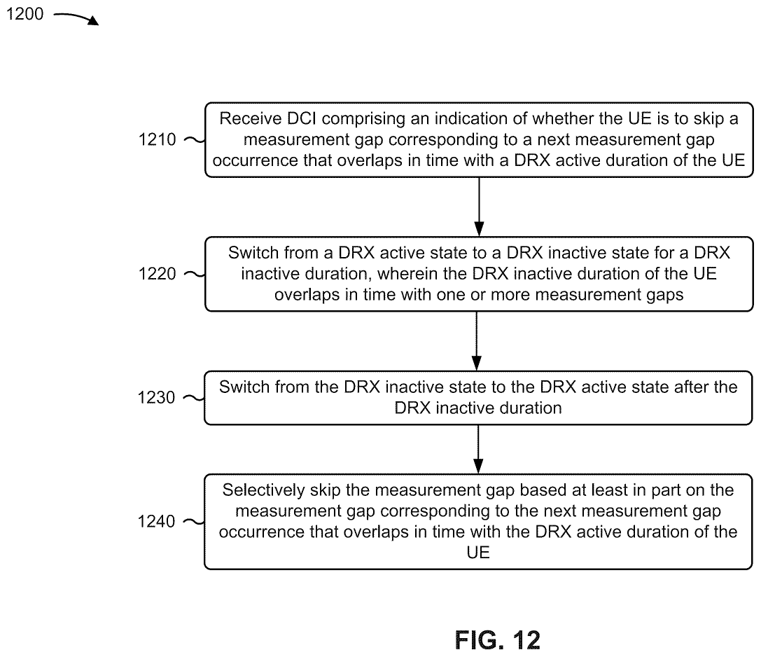

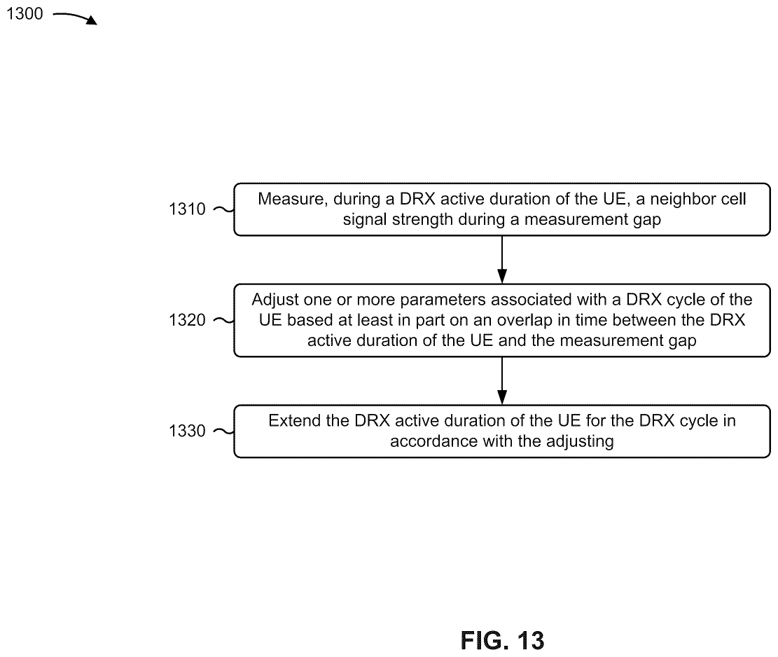

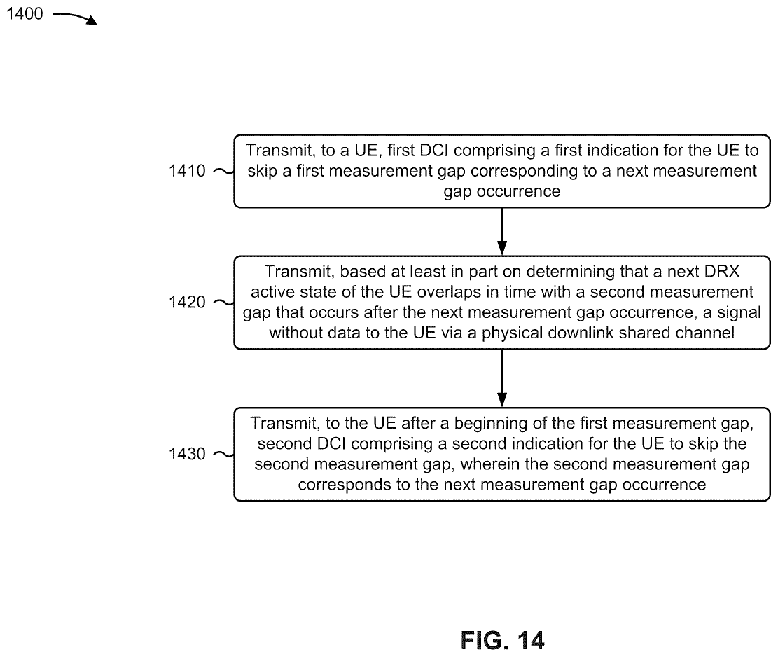

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with FIGS. 3-8, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, process 1100 of FIG. 11, process 1200 of FIG. 12, process 1300 of FIG. 13, process 1400 of FIG. 14, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context.

Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, process 1100 of FIG. 11, process 1200 of FIG. 12, process 1300 of FIG. 13, process 1400 of FIG. 14, or other processes as described herein. In some examples, executing instructions may include running the instructions, converting the instructions, compiling the instructions, and/or interpreting the instructions, among other examples.

In some aspects, the UE includes means for receiving DCI comprising a first indication of whether the UE is to skip a first measurement gap and a second indication of whether the UE is to skip a second measurement gap; means for selectively skipping the first measurement gap based at least in part on the first indication in the DCI; and/or means for selectively skipping the second measurement gap based at least in part on the second indication in the DCI.

In some aspects, the UE includes means for receiving signaling indicating a pattern of valid measurement gap occurrences and skipped measurement gap occurrences; means for measuring a neighbor cell signal strength during the valid measurement gap occurrences indicated by the pattern; and/or means for skipping measurement gaps that correspond to the skipped measurement gap occurrences indicated by the pattern.

In some aspects, the UE includes means for receiving signaling indicating for the UE to skip measurement gaps that overlap in a time domain with a DRX active duration of the UE; means for identifying one or more measurement gaps that overlap in the time domain with the DRX active duration of the UE; and/or means for skipping the one or more measurement gaps based at least in part on the one or more measurement gaps overlapping in the time domain with the DRX active duration of the UE.

In some aspects, the UE includes means for receiving DCI comprising an indication of whether the UE is to skip a measurement gap corresponding to a next measurement gap occurrence that overlaps in time with a DRX active duration of the UE; means for switching from a DRX active state to a DRX inactive state for a DRX inactive duration, wherein the DRX inactive duration of the UE overlaps in time with one or more measurement gaps; means for switching from the DRX inactive state to the DRX active state after the DRX inactive duration; and/or means for selectively skipping the measurement gap based at least in part on the measurement gap corresponding to the next measurement gap occurrence that overlaps in time with the DRX active duration of the UE.

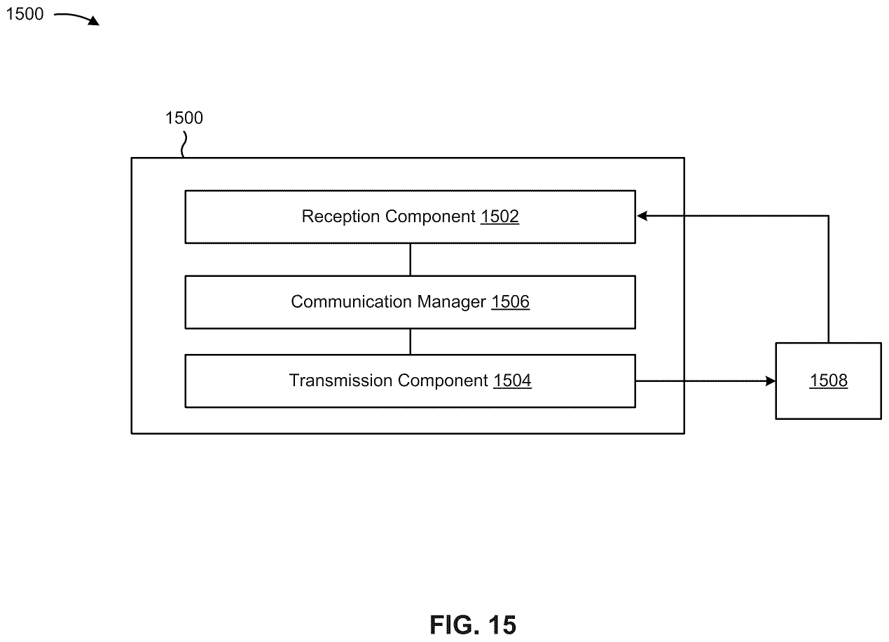

In some aspects, the UE includes means for measuring, during a DRX active duration of the UE, a neighbor cell signal strength during a measurement gap; means for adjusting one or more parameters associated with a DRX cycle of the UE based at least in part on an overlap in time between the DRX active duration of the UE and the measurement gap; and/or means for extending the DRX active duration of the UE for the DRX cycle in accordance with the adjusting. The means for the UE to perform operations described herein may include, for example, one or more of communication manager 150, processing system 140, a radio, one or more RF chains, one or more transceivers, one or more antennas, one or more modems, a reception component (for example, reception component 1502 depicted and described in connection with FIG. 15), and/or a transmission component (for example, transmission component 1504 depicted and described in connection with FIG. 15) , among other examples.

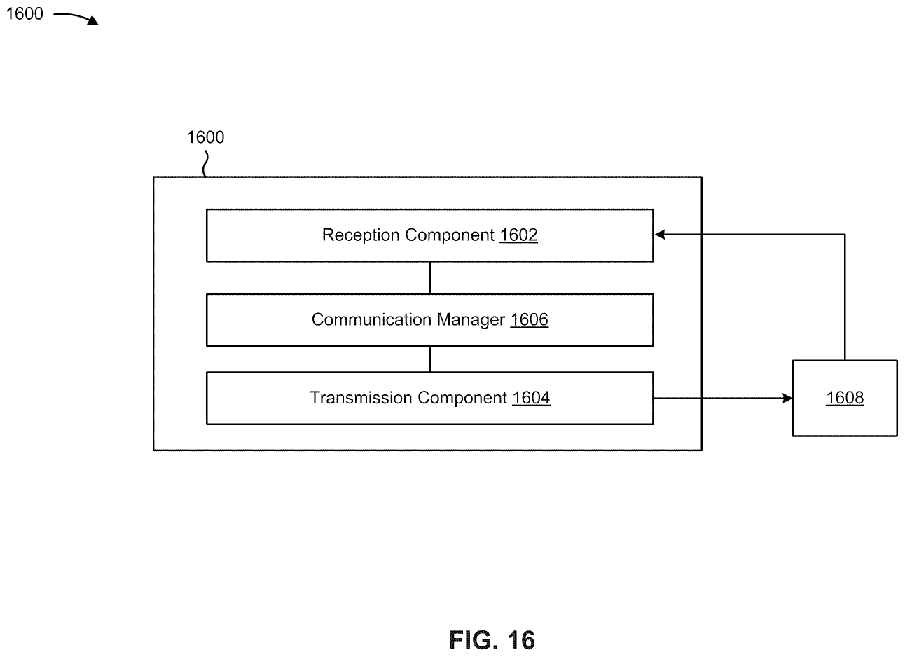

In some aspects, the network node includes means for transmitting, to a UE, first DCI comprising a first indication for the UE to skip a first measurement gap corresponding to a next measurement gap occurrence; means for transmitting, based at least in part on determining that a next DRX active state of the UE overlaps in time with a second measurement gap that occurs after the next measurement gap occurrence, a signal without data or a signal with dummy data to the UE via a PDSCH; and/or means for transmitting, to the UE after a beginning of the first measurement gap, second DCI comprising a second indication for the UE to skip the second measurement gap, wherein the second measurement gap corresponds to the next measurement gap occurrence. The means for the network node to perform operations described herein may include, for example, one or more of communication manager 155, processing system 145, a radio, one or more RF chains, one or more transceivers, one or more antennas, one or more modems, a reception component (for example, reception component 1602 depicted and described in connection with FIG. 16), and/or a transmission component (for example, transmission component 1604 depicted and described in connection with FIG. 16), among other examples.

FIG. 3 is a diagram illustrating an example 300 of measurement gap skipping, in accordance with the present disclosure. As shown in FIG. 3, a network node 110 and a UE 120 may communicate with one another.

In the example 300, the UE 120 may be configured with a DRX cycle that indicates a time between consecutive active states 305 of the UE 120. In some cases, the UE may transition between an active state 305 of the UE 120 and an inactive state 310 of the UE 120. The active state 305 may correspond to a DRX active duration of the UE 120, which may also be referred to as a DRX on duration of the UE 120. The inactive state 310 may correspond to a DRX inactive duration of the UE 120, which may also be referred to as a DRX off time. The DRX cycle may correspond to a power-saving mechanism where the UE 120 alternates between the active states 305 and the inactive states 310 to reduce energy consumption while maintaining the ability to receive data. In particular, the UE 120 may be listening for signals and capable of receiving data while in the active states 305, and the UE 120 may sleep or reduces activity to conserve power while in the inactive states 310. In some cases, the UE 120 may perform DRX according to one or more DRX parameters (e.g., that are configured by the network node 110). The one or DRX parameters may include a DRX inactive timer (e.g., that corresponds to amount of time in the inactive state 310), a DRX on duration timer (e.g., that corresponds to the amount of time in the active state 305), and a period or DRX cycle length. In one example, the DRX cycle may correspond to 100/3 ms. In some cases, a UE 120 may skip measurement gaps that overlap with an inactive state 310 of the UE 120. Additionally, or alternatively, the UE 120 may perform one or more measurements of a neighboring serving cell within measurement gaps 315 that overlap with the inactive state 310 of the UE 120.

The example 300 also illustrates a set of measurement gaps 315. During each measurement gap 315, the UE 120 may be unable to perform any communications with the network node 110, and may instead perform one or more measurements on a neighboring serving cell (or some other cell other than the serving cell associated with the network node 110). The example 300 further illustrates burst traffic 335. The burst traffic 335 may include XR traffic. In some cases, the burst traffic 335 may be periodic according to a non-integer periodicity. For example, the burst traffic 335 may arrive (e.g., at the network node 110) according to a multimedia cadence of 30 Hz. Here, the burst traffic 335 may be periodic according to a 33.33 ms periodicity.

In the example 300, the network node 110 may provide the burst traffic 335 to the UE 120 within a corresponding downlink transmission 330 that aligns with the active states 305 of the UE 120. For example, the downlink transmission 330a may carry the burst traffic 335a to the UE 120 (e.g., via one or more PDSCHs 325 transmissions in the downlink transmission 330a), and the downlink transmission 330a may align with the active state 305a. Additionally, the downlink transmission 330b may carry the burst traffic 335b to the UE 120 (e.g., via one or more PDSCHs 325 in the downlink transmission 330b), and the downlink transmission 330b may align with the active state 305b. Further, the downlink transmission 330c may carry the burst traffic 335c to the UE 120 (e.g., via one or more PDSCHs 325 in the downlink transmission 330c), and the downlink transmission 330c may align with the active state 305c.

Example 300 illustrates a scenario where the network node 110 may be unable to indicate for the UE 120 to skip the measurement gap 315b. In particular, the network node 110 may indicate, via a skipping indication 340 in the DCI 320, for the UE 120 skip a next measurement gap occurrence, which may correspond to the measurement gap 315a. In some cases, the skipping indication 340 may include a single bit in the DCI 320 indicative of whether the UE 120 is to skip a next measurement gap occurrence.

However, the network node 110 may be unable to transmit a DCI 320 after the measurement gap 315a (e.g., to indicate for the UE 120 to skip the measurement gap 315b) based on the UE 120 being in the inactive state 310a prior to the measurement gap 315b. That is, if there is a measurement gap 315a that occurs during the inactive state 310a, the network node 110 may not be able to indicate for the UE 120 to skip the next (e.g., subsequent) measurement gap 315b before the UE 120 enters the inactive state 310a. Even if the UE 120 transitions to the active state 305b prior to the measurement gap 315b, the UE 120 may begin a transition (e.g., a reconfiguration of one or more elements of its receiver to tune to frequencies other than that of the serving cell) to prepare for the measurement gap 315b prior to a beginning of the measurement gap 315b. That is, a skipping indication 340 received after the UE 120 begins the transition (e.g., more than a minimum time offset prior to the measurement gap 315b) may not trigger the UE 120 to skip the measurement gap 315b. Accordingly, the network node 110 may be unable to transmit a DCI 320 indicating for the UE 120 to skip the measurement gap 315b.

Accordingly, the UE 120 may switch to the active state 305b and may not skip the measurement gap 315b. Therefore, the network node 110 may cancel the downlink transmission 330b, and may delay the transmission of the burst traffic 335b. In the example 300, the active state 305b of the UE 120 may end during the measurement gap 315b, which may cause the network node 110 to delay the transmission of the burst traffic 335b until the next active state 305c of the UE 120. In the example 300, the network node 110 may transmit the burst traffic 335b and the burst traffic 335c to the UE 120 via the downlink transmission 330c.

In some other examples, and to avoid the delay of the burst traffic 335b, the network node 110 may indicate or otherwise configure the UE 120 (e.g., via DCI, via a MAC-CE, via RRC signaling) to skip the measurement gap 315b. In some other examples, the UE 120 may be configured to adjust one or more parameters associated with the DRX cycle of the UE 120 to extend the active state 305b based on the active state 305b overlapping in time with the measurement gap 315b. In some cases, this may enable the network node 110 to transmit the burst traffic 335b within the extended active state 305b instead of further delaying the transmission of the burst traffic 335b until the next active state 305c. In another example, the network node 110 may transmit signaling (e.g., comprising dummy data) to prevent the UE 120 from switching from the active state 305a to the inactive state 310a until the network node 110 is able to transmit a DCI 320 after a beginning of the measurement gap 315a, such that the DCI 320 may indicate for the UE 120 to skip the measurement gap 315b.

As indicated above, FIG. 3 is provided as an example. Other examples may differ from what is described with respect to FIG. 3.

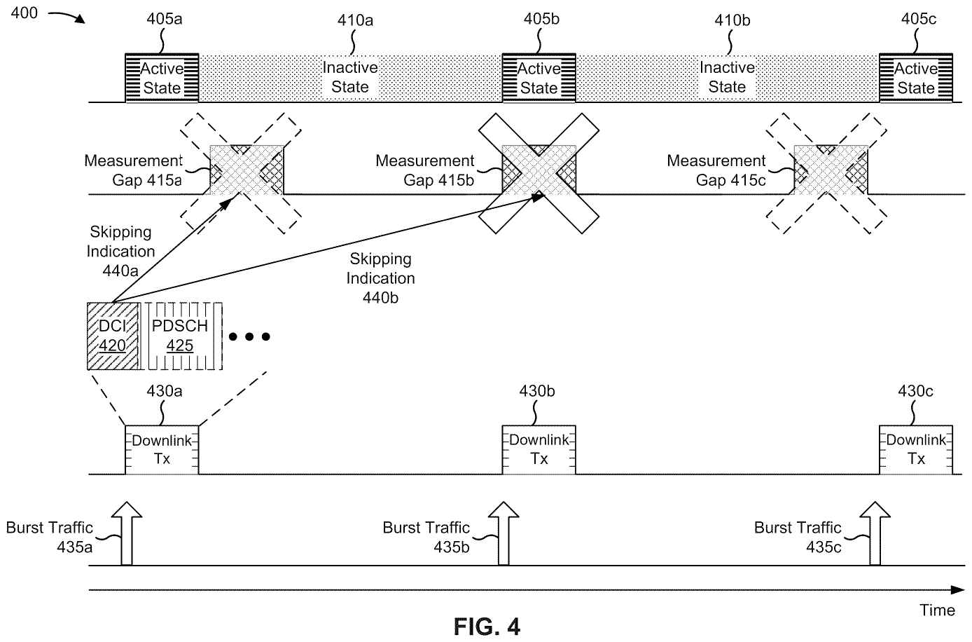

FIG. 4 is a diagram illustrating an example 400 of measurement gap skipping, in accordance with the present disclosure. As shown in FIG. 4, a network node 110 and a UE 120 may communicate with one another. Example 400 illustrates the network node 110 transmitting DCI 420a that includes more than one skipping indication 440 (e.g., the skipping indication 440a and the skipping indication 440b) and indicates, to the UE 120, whether to skip the next two measurement gap occurrences. Example 400 may include several aspects of other examples described herein. For example, the active states 405 and inactive states 410 may include aspects of the active states and inactive states described with reference to FIG. 3, the measurement gaps 415 may include aspects of the measurement gaps described with reference to FIG. 3, the downlink transmissions 430 may include aspects of the downlink transmissions described with reference to FIG. 3, and the burst traffic 435 may include aspects of the burst traffic described with reference to FIG. 3.

In the example 400, the UE 120 may be configured with a DRX cycle where the UE 120 transitions between an active state 405 of the UE 120 and an inactive state 410 of the UE 120. In the example 400, the network node 110 may provide the burst traffic 435 to the UE 120 within a corresponding downlink transmission 430 that aligns with the active states 405 of the UE 120. For example, the downlink transmission 430a may carry the burst traffic 435a to the UE 120 (e.g., via one or more PDSCHs 425 transmissions in the downlink transmission 430a), and the downlink transmission 430a may align with the active state 405a. Additionally, the downlink transmission 430b may carry the burst traffic 435b to the UE 120 (e.g., via one or more PDSCHs 425 in the downlink transmission 430b), and the downlink transmission 430b may align with the active state 405b. Further, the downlink transmission 430c may carry the burst traffic 435c to the UE 120 (e.g., via one or more PDSCHs 425 in the downlink transmission 430c), and the downlink transmission 430c may align with the active state 405c.

The example 400 illustrates an example where the network node 110 includes multiple skipping indications 440 within the DCI 420. While the example 400 illustrates the DCI 420 including two skipping indications 440, the DCI 420 may include a different quantity of skipping indications 440 (e.g., one skipping indication 440 or more than two skipping indications 440). The network node 110 may indicate, to the UE 120, a quantity of the skipping indications 440 that are included in the DCI 420 (which may be a scheduling DCI). For example, the network node 110 may indicate the quantity of the skipping indications 440 that are included in the DCI 420 in an RRC configuration (e.g., via RRC signaling). In some cases, the network node 110 may indicate the quantity of skipping indications 440 that are included in the DCI 420 by indicated a quantity of bits in the DCI 420 that are assigned to indicate the skipping indications 440. For example, to configure the DCI 420 to include two skipping indications 440, the network node 110 may indicate that two bits within the DCI 420 are assigned to indicate the skipping indications 440. Here, a most significant bit of the two bits may include the skipping indication 440a associated with a next measurement gap 415a and a least significant bit of the two bits may correspond to the skipping indication 44b associated with the second measurement gap 415b.

The UE 120 may determine whether to skip the measurement gap 415a based on whether the skipping indication 440a indicates for the UE 120 to skip the measurement gap 415a. For example, if the skipping indication 440a indicates for the UE 120 to skip the measurement gap 415a, the UE 120 may not perform one or more measurements of a neighboring cell during the measurement gap 415a. Additionally, if the skipping indication 440a indicates for the UE 120 to refrain from skipping the measurement gap 415a, the UE 120 may perform one or more measurements of a neighboring cell during the measurement gap 415a. Further, if the skipping indication 440b indicates for the UE 120 to skip the measurement gap 415b, the UE 120 may not perform one or more measurements of a neighboring cell during the measurement gap 415b. Additionally, if the skipping indication 440b indicates for the UE 120 to refrain from skipping the measurement gap 415b, the UE 120 may perform one or more measurements of a neighboring cell during the measurement gap 415b.

In the example 400, the network node 110 may indicate for the UE 120 to skip the measurement gap 415b via the skipping indication 440b based on the measurement gap 415b overlapping with the active state 405b. Therefore, the network node 110 may transmit the burst traffic 435 b to the UE 120 within the downlink transmission 430b instead of delaying the transmission of the burst traffic 435b to the UE 120 from the downlink transmission 430b to the downlink transmission 430c.

In some cases, the network node 110 may transmit the skipping indications 440 via a scheduling DCI (such as the DCI 420) that does not include any scheduling information. For example, the scheduling DCI (which may also be referred to as “dummy DCI”) may not include PDSCH scheduling information or any PUSCH grant information. Because the DCI 420 does not include any scheduling information, the UE 120 may not send HARQ feedback for any corresponding data transmissions (e.g., for the PDSCH 425) and may not attempt to receive any data transmissions. This may allow the UE 120 to refrain from staring a HARQ round trip time (RTT) timer or a DRX retransmission timer in response to receiving the scheduling DCI. In some cases, the scheduling DCI may be for an uplink grant (e.g., a DCI format 0_x DCI) or for downlink scheduling (e.g., a DCI format 1_x DCI). The UE 120 may determine that the scheduling DCI does not include the scheduling information based on a scheduling field in the DCI 420 (e.g., a field that is configured to carry scheduling information such as a frequency domain resource allocation (FDRA) or a time domain resource allocation (TDRA)) including an invalid entry. For example, an FDRA field of the DCI 420 may carry an out of valid range. In another example, the UE 120 may determine that the scheduling DCI does not include the scheduling information based on a scheduling field in the DCI 420 including a value indicative of the scheduling DCI being a dummy DCI. For example, a TDRA field in the DCI 420 may include a k0 value. In another example, the UE 120 may determine that the scheduling DCI does not include the scheduling information based on a field in the DCI 420 that indicates whether the DCI 420 is a dummy DCI including a value indicative of the DCI 420 being a dummy DCI.

As indicated above, FIG. 4 is provided as an example. Other examples may differ from what is described with respect to FIG. 4.

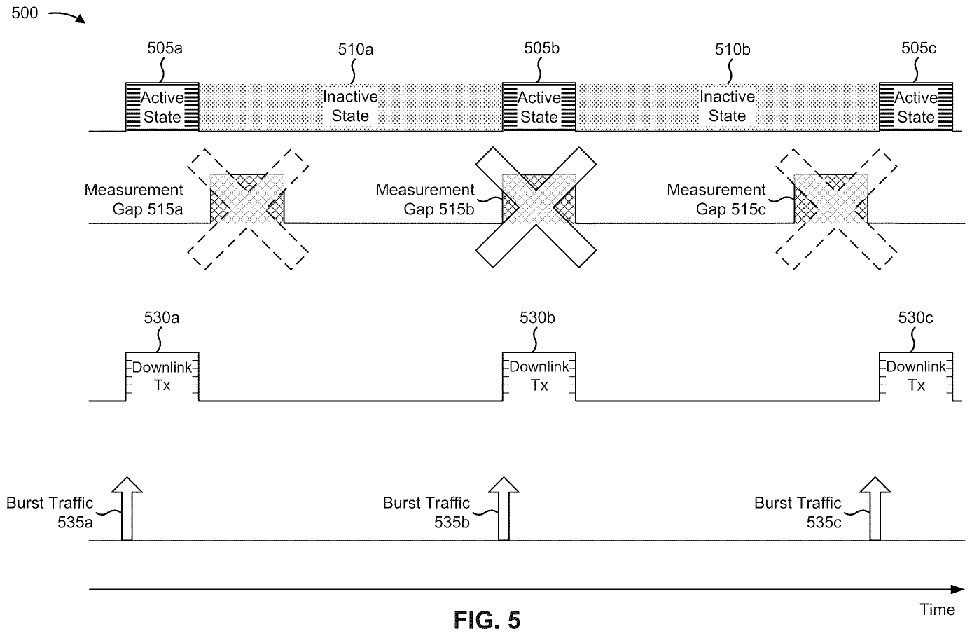

FIG. 5 is a diagram illustrating an example 500 of measurement gap skipping, in accordance with the present disclosure. As shown in FIG. 5, a network node 110 and a UE 120 may communicate with one another. Example 500 illustrates UE 120 skipping the measurement gap occasion based on a semi-static configuration or based on being configured to automatically skip measurement gaps 515 that overlap in time with an active state 505 of the UE 120. Example 500 may include several aspects of other examples described herein. For example, the active states 505 and inactive states 510 may include aspects of the active states and inactive states described with reference to FIGS. 3 and 4, the measurement gaps 515 may include aspects of the measurement gaps described with reference to FIGS. 3 and 4, the downlink transmissions 530 may include aspects of the downlink transmissions described with reference to FIGS. 3 and 4, and the burst traffic 535 may include aspects of the burst traffic described with reference to FIGS. 3 and 4.

In the example 500, the UE 120 may be configured with a DRX cycle where the UE 120 transitions between an active state 505 of the UE 120 and an inactive state 510 of the UE 120. In the example 500, the network node 110 may provide the burst traffic 535 to the UE 120 within a corresponding downlink transmission 530 that aligns with the active states 505 of the UE 120. For example, the downlink transmission 530a may carry the burst traffic 535a to the UE 120 (e.g., via one or more PDSCHs 525 transmissions in the downlink transmission 530a), and the downlink transmission 530a may align with the active state 505a. Additionally, the downlink transmission 530b may carry the burst traffic 535b to the UE 120 (e.g., via one or more PDSCHs 525 in the downlink transmission 530b), and the downlink transmission 530b may align with the active state 505b. Further, the downlink transmission 530c may carry the burst traffic 535c to the UE 120 (e.g., via one or more PDSCHs 525 in the downlink transmission 530c), and the downlink transmission 530c may align with the active state 505c.

In one case, the UE 120 may receive signaling indicating a pattern of valid measurement gap occurrences and skipped measurement gap occurrences. The valid measurement gap occurrences may correspond to measurement gaps 515 that the UE 120 is not configured to skip and the skipped measurement gap occurrences may correspond to measurement gaps 515 that the UE 120 is configured to skip. The pattern may indicate a periodic pattern of the valid measurement gap occurrences and the skipped measurement gap occurrences. In some cases, a periodicity of the periodic pattern may be based on a periodicity of the DRX cycle of the UE 120 and a periodicity of measurement gap occurrences. For example, if the measurement gaps 515 occur according to a 20 ms periodicity, and the UE 120 is configured with a DRX cycle of 100/3 ms, the network node 110 may indicate for the UE 120 to skip a measurement gap 515 every 100 ms, which may correspond to a least common multiple of the measurement gap 515 periodicity and the DRX cycle. In the example 500, the measurement gap 515a and the measurement gap 515c may correspond to valid measurement gap occurrences, and the measurement gap 515b may correspond to a skipped measurement gap occurrence.

The network node 110 may indicate the pattern via RRC signaling or a MAC-CE. In some cases, the network node 110 may determine the pattern based the measurement gaps 515 that overlap in time with an active state 505 of the UE 120. In some cases, the network node 110 may indicate the pattern via a bitmap. Here, each bit of the bitmap may correspond to a measurement gap occurrence. For example, a bitmap including the bits ‘01000’ may indicate to the UE 120 that every first, third, fourth, and fifth measurement gap occurrence are valid measurement gap occurrences, and every second measurement gap occurrence is an invalid measurement gap occurrence. In another example, a bitmap including the bits ‘10111’ may also indicate to the UE 120 that every first, third, fourth, and fifth measurement gap occurrence are valid measurement gap occurrences, and every second measurement gap occurrence is an invalid measurement gap occurrence.

In another case, the UE 120 may automatically skip measurement gaps 515 that overlap with the active state 505 of the UE 120. In some cases, the network node 110 may indicate for the UE 120 to automatically skip the measurement gaps 515 that overlap with the active state 505 of the UE 120 in a configuration of the measurement gaps 515 (e.g., via RRC signaling that indicates the configuration of the measurement gaps 515). In some cases, the UE 120 may determine to skip the measurement gap 515b based on the measurement gap 515b overlapping with the active state 505 for more than a threshold amount of time (e.g., that is predefined, that is configured by RRC signaling or a MAC-CE). In some other cases, the UE 120 may determine to skip the measurement gap 515b based on the measurement gap 515b completely overlapping with the active state 505. Additionally, the UE 120 may determine to skip the measurement gap 515b based on an amount of time it takes the UE 120 to enter and exit the measurement gap 515 (e.g., a minimum time offset before and/or after the measurement gap 515 for the UE 120 to tune to and/or from the serving cell).

Additionally, the network node 110 may dynamically indicate for the UE 120 to skip a next occurrence of a measurement gap 515 via DCI 520. In some cases, the network node 110 may transmit a skipping indication via a scheduling DCI (such as the DCI 520) that does not include any scheduling information. For example, the scheduling DCI may by dummy DCI, as described herein. In this example, the network node 110 may not transmit the PDSCH 525.

As indicated above, FIG. 5 is provided as an example. Other examples may differ from what is described with respect to FIG. 5.

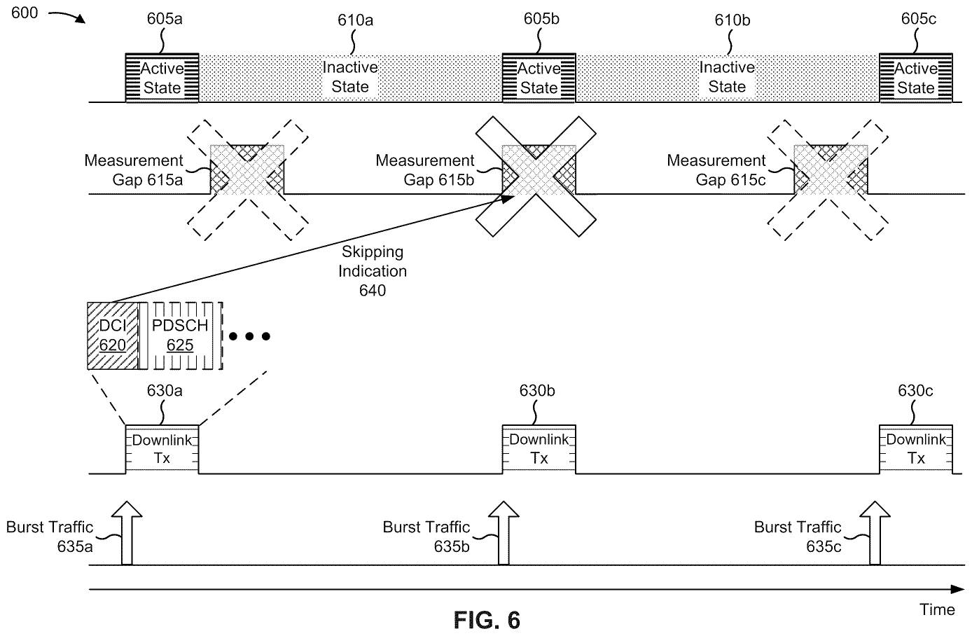

FIG. 6 is a diagram illustrating an example 600 of measurement gap skipping, in accordance with the present disclosure. As shown in FIG. 6, a network node 110 and a UE 120 may communicate with one another. Example 600 illustrates the network node 110 transmitting DCI 620 that includes a skipping indication 640 that indicates for the UE 120 to skip the next measurement gap occurrence that overlaps in time with the active state 605 of the UE 120. Example 600 may include several aspects of other examples described herein. For example, the active states 605 and inactive states 610 may include aspects of the active states and inactive states described with reference to FIGS. 3-5, the measurement gaps 615 may include aspects of the measurement gaps described with reference to FIGS. 3-5, the downlink transmissions 630 may include aspects of the downlink transmissions described with reference to FIGS. 3-5, and the burst traffic 635 may include aspects of the burst traffic described with reference to FIGS. 3-5.

In the example 600, the UE 120 may be configured with a DRX cycle where the UE 120 transitions between an active state 605 of the UE 120 and an inactive state 610 of the UE 120. In the example 600, the network node 110 may provide the burst traffic 635 to the UE 120 within a corresponding downlink transmission 630 that aligns with the active states 605 of the UE 120. For example, the downlink transmission 630a may carry the burst traffic 635a to the UE 120 (e.g., via one or more PDSCHs 625 transmissions in the downlink transmission 630a), and the downlink transmission 630a may align with the active state 605a. Additionally, the downlink transmission 630b may carry the burst traffic 635b to the UE 120 (e.g., via one or more PDSCHs 625 in the downlink transmission 630b), and the downlink transmission 630b may align with the active state 605b. Further, the downlink transmission 630c may carry the burst traffic 635c to the UE 120 (e.g., via one or more PDSCHs 625 in the downlink transmission 630c), and the downlink transmission 630c may align with the active state 605c.

In the example 600, skipping indication 640 included within the DCI 620 indicates for the UE 120 skip the next measurement gap 615 that overlaps in time with the active state 605 of the UE 120. That is, the skipping indication 640 may not apply to any measurement gaps 615 that occur after the UE 120 receives the DCI 620 and overlap in time with an inactive state 610 of the UE 120. Therefore, the skipping indication 640 indicates for the UE 120 to skip the measurement gap 615b, since the measurement gap 615b corresponds to the next measurement gap occurrence that overlaps with the active state 605b of the UE 120. Further, the UE 120 may determine that the skipping indication 640 does not apply to the measurement gap 615a because the measurement gap 615a does not overlap in time with the active state 605 of the UE 120.

The UE 120 may determine to skip the measurement gap 615a based on whether the UE 120 skips measurement gaps 615 that occur during the inactive state 610 of the UE 120, as described herein. Additionally, the UE 120 may determine whether to skip the measurement gap 615b based on whether the skipping indication 640 indicates for the UE 120 to skip the next measurement gap occurrence that overlaps in time with the active state 605 of the UE 120. For example, if the skipping indication 640 indicates for the UE 120 to skip the next measurement gap occurrence that overlaps in time with the active state 605, the UE 120 may skip the measurement gap 615b based on the measurement gap 615b overlapping in time with the active state 605b of the UE 120 and may therefore not perform one or more measurements of a neighboring cell during the measurement gap 615b. Additionally, if the skipping indication 640b indicates for the UE 120 to refrain from skipping the next measurement gap occurrence that overlaps in time with the active state 605, the UE 120 may perform one or more measurements of a neighboring cell during the measurement gap 615b. Additionally, the UE 120 may determine whether to skip the measurement gap 615b or a next measurement gap occurrence that overlaps in time with the active state 605 of the UE 120 based on an amount of time between receiving the skipping indication 640 and the beginning of the measurement gap 615b (e.g., and if the UE 120 is already preparing for the measurement gap 615b when the UE 120 receives the skipping indication 640).

That is, the determination may also be based on an amount of time it takes the UE 120 to enter and exit the measurement gap 615 (e.g., a minimum time offset before and/or after the measurement gap 615 for the UE 120 to tune to and/or from the serving cell).

In some cases, the network node 110 may transmit the skipping indications 640 via a scheduling DCI (such as the DCI 620) that does not include any scheduling information. For example, the scheduling DCI (which may also be referred to as “dummy DCI”) may not include PDSCH scheduling information or any PUSCH grant information. If the DCI 620 is a dummy DCI, the network node 110 may not transmit the PDSCH 625.

As indicated above, FIG. 6 is provided as an example. Other examples may differ from what is described with respect to FIG. 6.

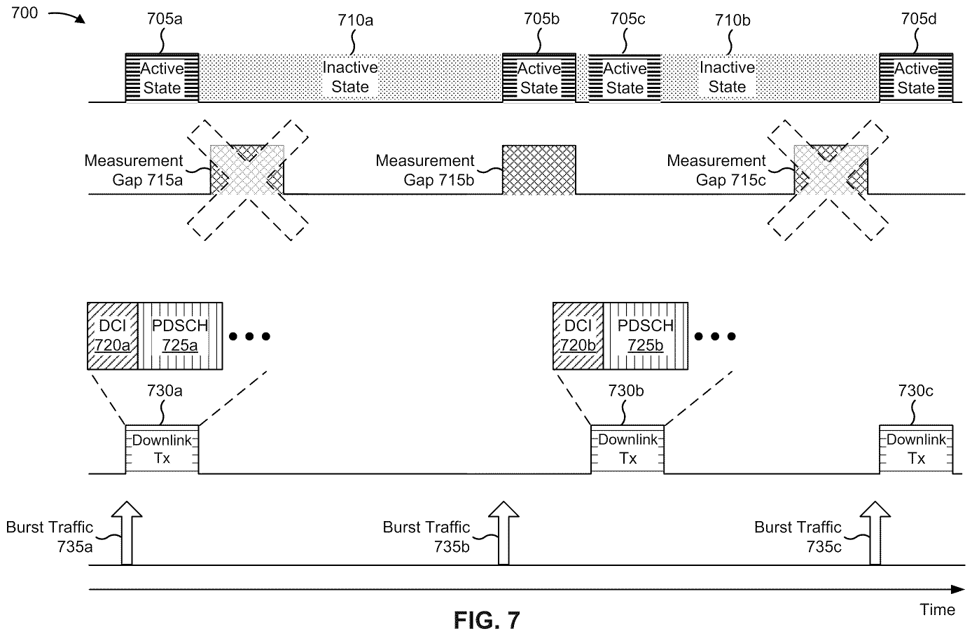

FIG. 7 is a diagram illustrating an example 700 of extending an active state of a UE in a DRX cycle, in accordance with the present disclosure. As shown in FIG. 7, a network node 110 and a UE 120 may communicate with one another. Example 700 illustrates the UE 120 adjusting one or more parameters associated with the DRX cycle to extend the active state 705 of the UE 120 in order to receive a downlink transmission 730 that otherwise would be delayed to a next active state 705 of the UE 120. Example 700 may include several aspects of other examples described herein. For example, the active states 705 and inactive states 710 may include aspects of the active states and inactive states described with reference to FIGS. 3-6, the measurement gaps 715 may include aspects of the measurement gaps described with reference to FIGS. 3-6, the downlink transmissions 730 may include aspects of the downlink transmissions described with reference to FIGS. 3-6, and the burst traffic 735 may include aspects of the burst traffic described with reference to FIGS. 3-6.

In the example 700, the UE 120 may be configured with a DRX cycle where the UE 120 transitions between an active state 705 of the UE 120 and an inactive state 710 of the UE 120. In the example 700, the network node 110 may provide the burst traffic 735 to the UE 120 within a corresponding downlink transmission 730 that aligns with the active states 705 of the UE 120. For example, the downlink transmission 730a may carry the burst traffic 735a to the UE 120 (e.g., via one or more PDSCHs 725 transmissions in the downlink transmission 730a), and the downlink transmission 730a may align with the active state 705a. Additionally, the downlink transmission 730b may carry the burst traffic 735b to the UE 120 (e.g., via one or more PDSCHs 725 in the downlink transmission 730b), and the downlink transmission 730b may align with the active state 705b. Further, the downlink transmission 730c may carry the burst traffic 735c to the UE 120 (e.g., via one or more PDSCHs 725 in the downlink transmission 730c), and the downlink transmission 730c may align with the active state 705c.

In the example 700, the network node 110 may refrain from transmitting the downlink transmission 730b during the active state 705b of the UE 120 based on the active state 705 overlapping in time with the measurement gap 715b. That is, the UE 120 may be performing one or more measurements of a neighboring cell during the measurement gap 715b and may unable to receive the downlink transmission 730b during the active state 705b. To prevent delaying the transmission of the burst traffic 735b (which may include low latency communications) until the downlink transmission 730c, the UE 120 may adjust one or more parameters associated with the DRX cycle to extend the active state 705 of the UE 120. In one example where the active state 705b of the UE 120 does not end prior to an end of the measurement gap 715b, the UE 120 may adjust one or more parameters associated with the DRX cycle to extend the length of the active state 705b (e.g., to also include the active state 705c). In another example where the active state 705b of the UE 120 ends prior to the end of the measurement gap 715b, the UE 120 may adjust one or more parameters associated with the DRX cycle to re-enter the active state 705c after the end of the measurement gap 715b. For example, the UE 120 may switch from the active state 705b to an inactive state 710, then may switch back to the active state 705c to receive the downlink transmission 730b.

The UE 120 may determine whether to adjust the one or more parameters of the DRX cycle based on whether a predefined or preconfigured condition is met. For example, the UE 120 may determine to adjust one or more parameters of the DRX cycle (e.g., to extend the amount of time in the active state 705) in response to a measurement gap 715 completely overlapping in time with the active state 705 of the UE 120. Adjusting the one or more parameters may include starting, restarting, or modifying one or more timers associated with the DRX cycle. For example, the UE 120 may adjust, restart, or modify a timer associated with the active state 705 (e.g., to restart or extend the active state 705) and/or adjust, restart, or modify a timer associated with the inactive state 710 (e.g., to decrease the inactive state 710 between the active state 705b and the active state 705c). In some cases, adjusting the one or more parameters associated with the DRX cycle may further be based on an amount of time it takes the UE 120 to enter and exit the measurement gap 715 (e.g., a minimum time offset before and/or after the measurement gap 715 for the UE 120 to tune to and/or from the serving cell).

As indicated above, FIG. 7 is provided as an example. Other examples may differ from what is described with respect to FIG. 7.

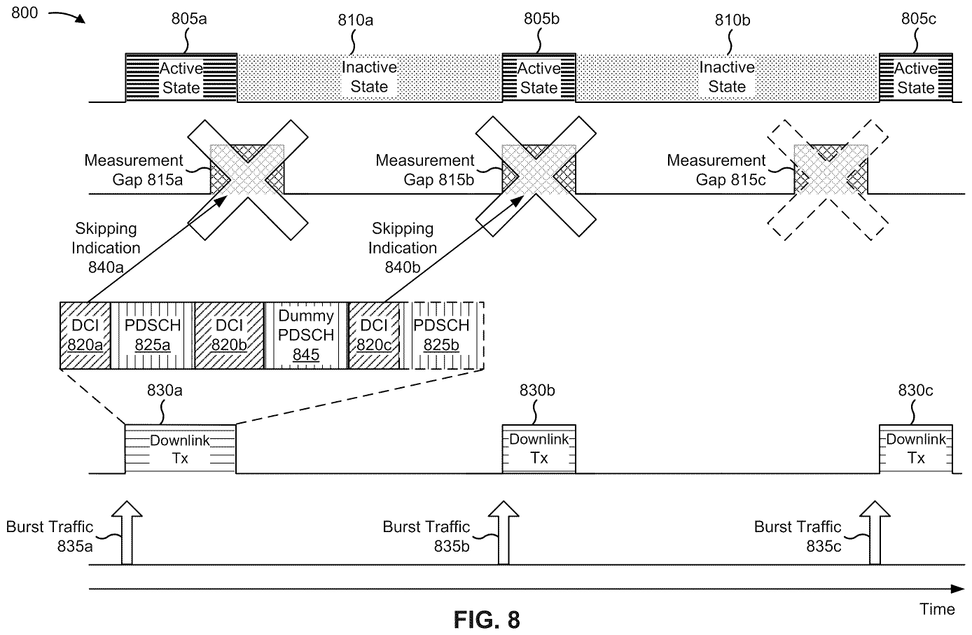

FIG. 8 is a diagram illustrating an example 800 of measurement gap skipping, in accordance with the present disclosure. As shown in FIG. 8, a network node 110 and a UE 120 may communicate with one another. Example 800 illustrates the network node 110 transmitting dummy PDSCH 845 to extend the active state 805a of the UE 120 until after the measurement gap 815a. Example 800 may include several aspects of other examples described herein. For example, the active states 805 and inactive states 810 may include aspects of the active states and inactive states described with reference to FIGS. 3-7, the measurement gaps 815 may include aspects of the measurement gaps described with reference to FIGS. 3-7, the downlink transmissions 830 may include aspects of the downlink transmissions described with reference to FIGS. 3-7, and the burst traffic 835 may include aspects of the burst traffic described with reference to FIGS. 3-7.

In the example 800, the UE 120 may be configured with a DRX cycle where the UE 120 transitions between an active state 805 of the UE 120 and an inactive state 810 of the UE 120. In the example 800, the network node 110 may provide the burst traffic 835 to the UE 120 within a corresponding downlink transmission 830 that aligns with the active states 805 of the UE 120. For example, the downlink transmission 830a may carry the burst traffic 835a to the UE 120 (e.g., via one or more PDSCH 825 transmissions in the downlink transmission 830a), and the downlink transmission 830a may align with the active state 805a. Additionally, the downlink transmission 830b may carry the burst traffic 835b to the UE 120 (e.g., via one or more PDSCHs 825 in the downlink transmission 830b), and the downlink transmission 830b may align with the active state 805b. Further, the downlink transmission 830c may carry the burst traffic 835c to the UE 120 (e.g., via one or more PDSCHs 825 in the downlink transmission 830c), and the downlink transmission 830c may align with the active state 805c.

In the example 800, the DCI 820a may optionally include a skipping indication 840a, which indicates for the UE 120 to skip the next measurement gap occurrence (e.g., the measurement gap 815a). To prevent the network node 110 from delaying the transmission of the burst traffic 835b within the downlink transmission 830b (e.g., due to the active state 805b overlapping the measurement gap 815b), the network node 110 may attempt to configure the UE 120 to skip the measurement gap 815b. However, if the active state 805a of the UE 120 ends prior to the measurement gap 815a, the network node 110 may be unable to indicate (e.g., via the DCI 820a) for the UE 120 to skip the measurement gap 815b, since the skipping indication 840a within the DCI 820 would correspond to the measurement gap 815a. Therefore, the network node 110 may extend the length of the downlink transmission 830a by adding the dummy PDSCH 845. In some cases, the dummy PDSCH 845 may corresponding to signaling that does not include any data for the UE 120 to decode. Based on extending the length of the downlink transmission 830a until after the start of the measurement gap 815a, the network node 110 may transmit the DCI 820c, which includes the skipping indication 840b. The skipping indication 840b may indicate for the UE 120 to skip the next measurement gap occurrence (e.g., the measurement gap 815b). Accordingly, the UE 120 may skip the measurement gap 815b and the network node 110 may not delay the transmission of the burst traffic 835b. In the example 800, the network node 110 may indicate for the UE 120 to skip the measurement gap 815a via the skipping indication 840a in order to enable the UE 120 to receive the DCI 820b, the dummy PDSCH 845, the DCI 820c, and/or the PDSCH 825b.

In some cases, the network node 110 may transmit the skipping indication 840b via a scheduling DCI (such as the DCI 820b) that does not include any scheduling information. For example, the scheduling DCI may by dummy DCI, as described herein. In this example, the network node 110 may not transmit the PDSCH 825b.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with skipping measurement gaps.

As shown in FIG. 9, in some aspects, process 900 may include receiving DCI comprising a first indication of whether the UE is to skip a first measurement gap and a second indication of whether the UE is to skip a second measurement gap (block 910). For example, the UE (e.g., using reception component 1502 and/or communication manager 1506, depicted in FIG. 15) may receive DCI comprising a first indication of whether the UE is to skip a first measurement gap and a second indication of whether the UE is to skip a second measurement gap, as described above.

As further shown in FIG. 9, in some aspects, process 900 may include selectively skipping the first measurement gap based at least in part on the first indication in the DCI (block 920). For example, the UE (e.g., using communication manager 1506, depicted in FIG. 15) may selectively skip the first measurement gap based at least in part on the first indication in the DCI, as described above.

As further shown in FIG. 9, in some aspects, process 900 may include selectively skipping the second measurement gap based at least in part on the second indication in the DCI (block 930). For example, the UE (e.g., using communication manager 1506, depicted in FIG. 15) may selectively skip the second measurement gap based at least in part on the second indication in the DCI, as described above.

Process 900 may include additional aspects, such as any single aspect or any combination of aspects described below and/or in connection with one or more other processes described elsewhere herein.

In a first aspect, process 900 includes receiving signaling configuring a quantity of indications within the DCI that indicate whether the UE is to skip measurement gaps, wherein receiving the DCI is based at least in part on receiving the signaling.

In a second aspect, alone or in combination with the first aspect, the configured quantity of indications within the DCI is one or more.

In a third aspect, alone or in combination with one or more of the first and second aspects, the signaling comprises RRC signaling.

In a fourth aspect, alone or in combination with one or more of the first through third aspects, process 900 includes the DCI comprises a first bit corresponding to the first indication, and the DCI comprises a second bit corresponding to the second indication.

In a fifth aspect, alone or in combination with one or more of the first through fourth aspects, the DCI is scheduling DCI that does not comprise PDSCH scheduling information or PUSCH grant information.

In a sixth aspect, alone or in combination with one or more of the first through fifth aspects, the scheduling DCI comprises a first field configured to carry scheduling information, the first field comprising an invalid value indicative of the scheduling DCI not comprising the PDSCH scheduling information or the PUSCH grant information, a second field configured to carry scheduling information, the second field comprising a predefined value indicative of the scheduling DCI not comprising the PDSCH scheduling information or the PUSCH grant information, or a third field configured to carry an indication of whether the scheduling DCI comprises the PDSCH scheduling information or the PUSCH grant information, the third field comprising a value indicative of the scheduling DCI not comprising the PDSCH scheduling information or the PUSCH grant information.

In a seventh aspect, alone or in combination with one or more of the first through sixth aspects, process 900 includes refraining from transmitting a HARQ transmission associated with the scheduling DCI, based at least in part on the scheduling DCI not comprising the PDSCH scheduling information or the PUSCH grant information.

In an eighth aspect, alone or in combination with one or more of the first through seventh aspects, process 900 includes refraining from restarting a DRX timer responsive to receiving the scheduling DCI, based at least in part on the scheduling DCI not comprising the PDSCH scheduling information or the PUSCH grant information.

In a ninth aspect, alone or in combination with one or more of the first through eighth aspects, process 900 includes selectively skipping the first measurement gap comprises skipping the first measurement gap in response to the first indication indicating for the UE to skip the first measurement gap, or measuring a neighbor cell signal strength during the first measurement gap in response to the first indication indicating for the UE to not skip the first measurement gap, and selectively skipping the second measurement gap comprises skipping the second measurement gap in response to the second indication indicating for the UE to skip the second measurement gap, or measuring the neighbor cell signal strength during the second measurement gap in response to the second indication indicating for the UE to not skip the second measurement gap.

In a tenth aspect, alone or in combination with one or more of the first through ninth aspects, the first measurement gap and the second measurement gap correspond to a next two scheduled occurrences of measurement gaps.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with skipping measurement gaps.

As shown in FIG. 10, in some aspects, process 1000 may include receiving signaling indicating a pattern of valid measurement gap occurrences and skipped measurement gap occurrences (block 1010). For example, the UE (e.g., using reception component 1502 and/or communication manager 1506, depicted in FIG. 15) may receive signaling indicating a pattern of valid measurement gap occurrences and skipped measurement gap occurrences, as described above.

As further shown in FIG. 10, in some aspects, process 1000 may include measuring a neighbor cell signal strength during the valid measurement gap occurrences indicated by the pattern (block 1020). For example, the UE (e.g., using communication manager 1506, depicted in FIG. 15) may measure a neighbor cell signal strength during the valid measurement gap occurrences indicated by the pattern, as described above.

As further shown in FIG. 10, in some aspects, process 1000 may include skipping measurement gaps that correspond to the skipped measurement gap occurrences indicated by the pattern (block 1030). For example, the UE (e.g., using communication manager 1506, depicted in FIG. 15) may skip measurement gaps that correspond to the skipped measurement gap occurrences indicated by the pattern, as described above.

Process 1000 may include additional aspects, such as any single aspect or any combination of aspects described below and/or in connection with one or more other processes described elsewhere herein.

In a first aspect, the signaling comprises a bitmap that indicates the pattern of the valid measurement gap occurrences and the skipped measurement gap occurrences.

In a second aspect, alone or in combination with the first aspect, process 1000 includes receiving DCI comprising an indication that the UE is to skip a next measurement gap occurrence, wherein the pattern indicates that the next measurement gap occurrence is a valid measurement gap occurrence, and skipping a measurement gap that corresponds to the next measurement gap occurrence in response to the DCI comprising the indication.

In a third aspect, alone or in combination with one or more of the first and second aspects, the DCI is scheduling DCI that does not comprise PDSCH scheduling information or PUSCH grant information.

In a fourth aspect, alone or in combination with one or more of the first through third aspects, the scheduling DCI comprises a first field configured to carry scheduling information, the first field comprising an invalid value indicative of the scheduling DCI not comprising the PDSCH scheduling information or the PUSCH grant information, a second field configured to carry scheduling information, the second field comprising a predefined value indicative of the scheduling DCI not comprising the PDSCH scheduling information or the PUSCH grant information, or a third field configured to carry an indication of whether the scheduling DCI comprises the PDSCH scheduling information or the PUSCH grant information, the third field comprising a value indicative of the scheduling DCI not comprising the PDSCH scheduling information or the PUSCH grant information.

In a fifth aspect, alone or in combination with one or more of the first through fourth aspects, process 1000 includes refraining from transmitting a HARQ transmission associated with the scheduling DCI, based at least in part on the scheduling DCI not comprising the PDSCH scheduling information or the PUSCH grant information.

In a sixth aspect, alone or in combination with one or more of the first through fifth aspects, process 1000 includes refraining from restarting a DRX timer responsive to receiving the scheduling DCI, based at least in part on the scheduling DCI not comprising the PDSCH scheduling information or the PUSCH grant information.

In a seventh aspect, alone or in combination with one or more of the first through sixth aspects, process 1000 includes the valid measurement gap occurrences at least partially overlap in a time domain with a DRX active duration of the UE, and the skipped measurement gap occurrences at least partially overlap in the time domain with a DRX inactive state of the UE.

In an eighth aspect, alone or in combination with one or more of the first through seventh aspects, the pattern indicates a periodic pattern of the valid measurement gap occurrences and the skipped measurement gap occurrences.

In a ninth aspect, alone or in combination with one or more of the first through eighth aspects, a periodicity of the periodic pattern is based at least in part on a periodicity of a DRX cycle of the UE and a periodicity of measurement gap occurrences.

In a tenth aspect, alone or in combination with one or more of the first through ninth aspects, the signaling indicating the pattern comprises RRC signaling or a MAC-CE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UE or an apparatus of a UE, in accordance with the present disclosure.

Example process 1100 is an example where the apparatus or the UE (e.g., UE 120) performs operations associated with skipping measurement gaps.

As shown in FIG. 11, in some aspects, process 1100 may include receiving signaling indicating for the UE to skip measurement gaps that overlap in a time domain with a DRX active duration of the UE (block 1110). For example, the UE (e.g., using reception component 1502 and/or communication manager 1506, depicted in FIG. 15) may receive signaling indicating for the UE to skip measurement gaps that overlap in a time domain with a DRX active duration of the UE, as described above.

As further shown in FIG. 11, in some aspects, process 1100 may include identifying one or more measurement gaps that overlap in the time domain with the DRX active duration of the UE (block 1120). For example, the UE (e.g., using communication manager 1506, depicted in FIG. 15) may identify one or more measurement gaps that overlap in the time domain with the DRX active duration of the UE, as described above.

As further shown in FIG. 11, in some aspects, process 1100 may include skipping the one or more measurement gaps based at least in part on the one or more measurement gaps overlapping in the time domain with the DRX active duration of the UE (block 1130). For example, the UE (e.g., using communication manager 1506, depicted in FIG. 15) may skip the one or more measurement gaps based at least in part on the one or more measurement gaps overlapping in the time domain with the DRX active duration of the UE, as described above.

Process 1100 may include additional aspects, such as any single aspect or any combination of aspects described below and/or in connection with one or more other processes described elsewhere herein.

In a first aspect, process 1100 includes the signaling indicates a measurement gap configuration for the UE, and the measurement gap configuration indicates for the UE to skip the measurement gaps associated with the measurement gap configuration that overlap in the time domain with the DRX active duration of the UE.

In a second aspect, alone or in combination with the first aspect, the signaling comprises RRC signaling.

In a third aspect, alone or in combination with one or more of the first and second aspects, identifying the one or more measurement gaps comprises identifying the one or more measurement gaps that overlap with the DRX active duration of the UE for at least a threshold amount of time.

In a fourth aspect, alone or in combination with one or more of the first through third aspects, process 1100 includes receiving control information configuring the threshold amount of time, wherein the identifying is based at least in part on receiving the control information.

In a fifth aspect, alone or in combination with one or more of the first through fourth aspects, the threshold amount of time corresponds to a duration of one measurement gap.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a UE or an apparatus of a UE, in accordance with the present disclosure.

Example process 1200 is an example where the apparatus or the UE (e.g., UE 120) performs operations associated with skipping measurement gaps.

As shown in FIG. 12, in some aspects, process 1200 may include receiving DCI comprising an indication of whether the UE is to skip a measurement gap corresponding to a next measurement gap occurrence that overlaps in time with a DRX active duration of the UE (block 1210). For example, the UE (e.g., using reception component 1502 and/or communication manager 1506, depicted in FIG. 15) may receive DCI comprising an indication of whether the UE is to skip a measurement gap corresponding to a next measurement gap occurrence that overlaps in time with a DRX active duration of the UE, as described above.

As further shown in FIG. 12, in some aspects, process 1200 may include switching from a DRX active state to a DRX inactive state for a DRX inactive duration, wherein the DRX inactive duration of the UE overlaps in time with one or more measurement gaps (block 1220). For example, the UE (e.g., using communication manager 1506, depicted in FIG. 15) may switch from a DRX active state to a DRX inactive state for a DRX inactive duration, wherein the DRX inactive duration of the UE overlaps in time with one or more measurement gaps, as described above.

As further shown in FIG. 12, in some aspects, process 1200 may include switching from the DRX inactive state to the DRX active state after the DRX inactive duration (block 1230). For example, the UE (e.g., using communication manager 1506, depicted in FIG. 15) may switch from the DRX inactive state to the DRX active state after the DRX inactive duration, as described above.

As further shown in FIG. 12, in some aspects, process 1200 may include selectively skipping the measurement gap based at least in part on the measurement gap corresponding to the next measurement gap occurrence that overlaps in time with the DRX active duration of the UE (block 1240). For example, the UE (e.g., using communication manager 1506, depicted in FIG. 15) may selectively skip the measurement gap based at least in part on the measurement gap corresponding to the next measurement gap occurrence that overlaps in time with the DRX active duration of the UE, as described above.

Process 1200 may include additional aspects, such as any single aspect or any combination of aspects described below and/or in connection with one or more other processes described elsewhere herein.

In a first aspect, the next measurement gap occurrence that overlaps in time with the DRX active duration of the UE occurs after the DCI is received and after the one or more measurement gaps that overlap in time with the DRX inactive duration of the UE.

In a second aspect, alone or in combination with the first aspect, the DCI is scheduling DCI that does not comprise PDSCH scheduling information or PUSCH grant information.

In a third aspect, alone or in combination with one or more of the first and second aspects, the scheduling DCI comprises a first field configured to carry scheduling information, the first field comprising an invalid entry indicative of the scheduling DCI not comprising the PDSCH scheduling information or the PUSCH grant information, a second field configured to carry scheduling information, the second field comprising a predefined value indicative of the scheduling DCI not comprising the PDSCH scheduling information or the PUSCH grant information, or a third field configured to carry an indication of whether the scheduling DCI comprises the PDSCH scheduling information or the PUSCH grant information, the third field comprising a value indicative of the scheduling DCI not comprising the PDSCH scheduling information or the PUSCH grant information.

In a fourth aspect, alone or in combination with one or more of the first through third aspects, process 1200 includes refraining from transmitting a HARQ transmission associated with the scheduling DCI, based at least in part on the scheduling DCI not comprising the PDSCH scheduling information or the PUSCH grant information.

In a fifth aspect, alone or in combination with one or more of the first through fourth aspects, process 1200 includes refraining from restarting a DRX timer responsive to receiving the scheduling DCI, based at least in part on the scheduling DCI not comprising the PDSCH scheduling information or the PUSCH grant information.

In a sixth aspect, alone or in combination with one or more of the first through fifth aspects, the DCI comprises a single bit corresponding to the indication.

In a seventh aspect, alone or in combination with one or more of the first through sixth aspects, selectively skipping the measurement gap comprises skipping the measurement gap in response to the indication indicating for the UE to skip the measurement gap, or measuring a neighbor cell signal strength during the measurement gap in response to the indication indicating for the UE to not skip the measurement gap.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a UE or an apparatus of a UE, in accordance with the present disclosure.

Example process 1300 is an example where the apparatus or the UE (e.g., UE 120) performs operations associated with skipping measurement gaps.

As shown in FIG. 13, in some aspects, process 1300 may include measuring, during a DRX active duration of the UE, a neighbor cell signal strength during a measurement gap (block 1310). For example, the UE (e.g., using communication manager 1506, depicted in FIG. 15) may measure, during a DRX active duration of the UE, a neighbor cell signal strength during a measurement gap, as described above.

As further shown in FIG. 13, in some aspects, process 1300 may include adjusting one or more parameters associated with a DRX cycle of the UE based at least in part on an overlap in time between the DRX active duration of the UE and the measurement gap (block 1320). For example, the UE (e.g., using communication manager 1506, depicted in FIG. 15) may adjust one or more parameters associated with a DRX cycle of the UE based at least in part on an overlap in time between the DRX active duration of the UE and the measurement gap, as described above.

As further shown in FIG. 13, in some aspects, process 1300 may include extending the DRX active duration of the UE for the DRX cycle in accordance with the adjusting (block 1330). For example, the UE (e.g., using communication manager 1506, depicted in FIG. 15) may extend the DRX active duration of the UE for the DRX cycle in accordance with the adjusting, as described above.

Process 1300 may include additional aspects, such as any single aspect or any combination of aspects described below and/or in connection with one or more other processes described elsewhere herein.

In a first aspect, process 1300 includes switching from a DRX active state of the UE to a DRX inactive state of the UE after the measurement gap, and switching from the DRX inactive state to the DRX active state during the DRX cycle based at least in part on the adjusting, wherein extending the DRX active duration of the UE is based at least in part on switching to the DRX active state.

In a second aspect, alone or in combination with the first aspect, process 1300 includes refraining from switching from a DRX active state of the UE to a DRX inactive state of the UE after the measurement gap, based at least in part on the adjusting, wherein extending the DRX active duration of the UE is based at least in part on the refraining.

In a third aspect, alone or in combination with one or more of the first and second aspects, adjusting the one or more parameters comprises adjusting a DRX inactive timer or adjusting a DRX on duration timer.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with skipping measurement gaps.

As shown in FIG. 14, in some aspects, process 1400 may include transmitting, to a UE, first DCI comprising a first indication for the UE to skip a first measurement gap corresponding to a next measurement gap occurrence (block 1410). For example, the network node (e.g., using transmission component 1604 and/or communication manager 1606, depicted in FIG. 16) may transmit, to a UE, first DCI comprising a first indication for the UE to skip a first measurement gap corresponding to a next measurement gap occurrence, as described above.

As further shown in FIG. 14, in some aspects, process 1400 may include transmitting, based at least in part on determining that a next DRX active state of the UE overlaps in time with a second measurement gap that occurs after the next measurement gap occurrence, a signal without data or a signal with dummy data to the UE via a PDSCH (block 1420). For example, the network node (e.g., using transmission component 1604 and/or communication manager 1606, depicted in FIG. 16) may transmit, based at least in part on determining that a next DRX active state of the UE overlaps in time with a second measurement gap that occurs after the next measurement gap occurrence, a signal without data or a signal with dummy data to the UE via a PDSCH, as described above.

As further shown in FIG. 14, in some aspects, process 1400 may include transmitting, to the UE after a beginning of the first measurement gap, second DCI comprising a second indication for the UE to skip the second measurement gap, wherein the second measurement gap corresponds to the next measurement gap occurrence (block 1430). For example, the network node (e.g., using transmission component 1604 and/or communication manager 1606, depicted in FIG. 16) may transmit, to the UE after a beginning of the first measurement gap, second DCI comprising a second indication for the UE to skip the second measurement gap, wherein the second measurement gap corresponds to the next measurement gap occurrence, as described above.

Process 1400 may include additional aspects, such as any single aspect or any combination of aspects described below and/or in connection with one or more other processes described elsewhere herein.

In a first aspect, transmitting the signal without the data is further based at least in part on determining that a current DRX active duration of the UE ends prior to the beginning of the first measurement gap absent any transmissions from the network node to the UE.

In a second aspect, alone or in combination with the first aspect, the first DCI or the second DCI is scheduling DCI that does not comprise PDSCH scheduling information or PUSCH grant information.

In a third aspect, alone or in combination with one or more of the first and second aspects, the scheduling DCI comprises a first field configured to carry scheduling information, the first field comprising an invalid value indicative of the scheduling DCI not comprising the PDSCH scheduling information or the PUSCH grant information, a second field configured to carry scheduling information, the second field comprising a predefined value indicative of the scheduling DCI not comprising the PDSCH scheduling information or the PUSCH grant information, or a third field configured to carry an indication of whether the scheduling DCI comprises the PDSCH scheduling information or the PUSCH grant information, the third field comprising a value indicative of the scheduling DCI not comprising the PDSCH scheduling information or the PUSCH grant information.

In a fourth aspect, alone or in combination with one or more of the first through third aspects, process 1400 includes refraining from monitoring for a HARQ transmission from the UE that is associated with the scheduling DCI, based at least in part on the scheduling DCI not comprising the PDSCH scheduling information or the PUSCH grant information.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 140 described in connection with FIG. 1) of the UE.

In some aspects, the apparatus 1500 may be configured to perform one or more operations described herein in connection with FIGS. 3-8. Additionally, or alternatively, the apparatus 1500 may be configured to perform one or more processes described herein, such as process 900 in FIG. 9, process 1000 in FIG. 10, process 1100 in FIG. 11, process 1200 in FIG. 12, or a combination thereof. In some aspects, the apparatus 1500 and/or one or more components shown in FIG. 15 may include one or more components of the UE described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the UE described above in connection with FIG. 1, such as a radio, one or more RF chains, one or more transceivers, or one or more modems, each of which may in turn be coupled with one or more antennas of the UE.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1504 may be co-located with the reception component 1502.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 may receive DCI comprising a first indication of whether the UE is to skip a first measurement gap and a second indication of whether the UE is to skip a second measurement gap. The communication manager 1506 may selectively skip the first measurement gap based at least in part on the first indication in the DCI. The communication manager 1506 may selectively skip the second measurement gap based at least in part on the second indication in the DCI.

The reception component 1502 may receive signaling configuring a quantity of indications within the DCI that indicate whether the UE is to skip measurement gaps, wherein receiving the DCI is based at least in part on receiving the signaling.

The communication manager 1506 may refrain from transmitting a HARQ transmission associated with the scheduling DCI, based at least in part on the scheduling DCI not comprising the PDSCH scheduling information or the PUSCH grant information.

The communication manager 1506 may refrain from restarting a DRX timer responsive to receiving the scheduling DCI, based at least in part on the scheduling DCI not comprising the PDSCH scheduling information or the PUSCH grant information.

The communication manager 1506 may selectively skip the first measurement gap comprises skipping the first measurement gap in response to the first indication indicating for the UE to skip the first measurement gap, or measuring a neighbor cell signal strength during the first measurement gap in response to the first indication indicating for the UE to not skip the first measurement gap.

The communication manager 1506 may selectively skip the second measurement gap comprises skipping the second measurement gap in response to the second indication indicating for the UE to skip the second measurement gap, or measuring the neighbor cell signal strength during the second measurement gap in response to the second indication indicating for the UE to not skip the second measurement gap.

The reception component 1502 may receive signaling indicating a pattern of valid measurement gap occurrences and skipped measurement gap occurrences. The communication manager 1506 may measure a neighbor cell signal strength during the valid measurement gap occurrences indicated by the pattern. The communication manager 1506 may skip measurement gaps that correspond to the skipped measurement gap occurrences indicated by the pattern.

The reception component 1502 may receive DCI comprising an indication that the UE is to skip a next measurement gap occurrence, wherein the pattern indicates that the next measurement gap occurrence is a valid measurement gap occurrence.

The communication manager 1506 may skip a measurement gap that corresponds to the next measurement gap occurrence in response to the DCI comprising the indication.

The reception component 1502 may receive signaling indicating for the UE to skip measurement gaps that overlap in a time domain with a DRX active duration of the UE. The communication manager 1506 may identify one or more measurement gaps that overlap in the time domain with the DRX active duration of the UE. The communication manager 1506 may skip the one or more measurement gaps based at least in part on the one or more measurement gaps overlapping in the time domain with the DRX active duration of the UE.

The reception component 1502 may receive control information configuring the threshold amount of time, wherein the identifying is based at least in part on receiving the control information.

The reception component 1502 may receive DCI comprising an indication of whether the UE is to skip a measurement gap corresponding to a next measurement gap occurrence that overlaps in time with a DRX active duration of the UE. The communication manager 1506 may switch from a DRX active state to a DRX inactive state for a DRX inactive duration, wherein the DRX inactive duration of the UE overlaps in time with one or more measurement gaps. The communication manager 1506 may switch from the DRX inactive state to the DRX active state after the DRX inactive duration. The communication manager 1506 may selectively skip the measurement gap based at least in part on the measurement gap corresponding to the next measurement gap occurrence that overlaps in time with the DRX active duration of the UE.

The communication manager 1506 may measure, during a DRX active duration of the UE, a neighbor cell signal strength during a measurement gap. The communication manager 1506 may adjust one or more parameters associated with a DRX cycle of the UE based at least in part on an overlap in time between the DRX active duration of the UE and the measurement gap. The communication manager 1506 may extend the DRX active duration of the UE for the DRX cycle in accordance with the adjusting.

The communication manager 1506 may switch from a DRX active state of the UE to a DRX inactive state of the UE after the measurement gap.

The communication manager 1506 may switch from the DRX inactive state to the DRX active state during the DRX cycle based at least in part on the adjusting, wherein extending the DRX active duration of the UE is based at least in part on switching to the DRX active state.

The communication manager 1506 may refrain from switching from a DRX active state of the UE to a DRX inactive state of the UE after the measurement gap, based at least in part on the adjusting, wherein extending the DRX active duration of the UE is based at least in part on the refraining.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 155 described in connection with FIG. 1. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system (for example, the processing system 145 described in connection with FIG. 1) of the network node.

In some aspects, the apparatus 1600 may be configured to perform one or more operations described herein in connection with FIGS. 3-8. Additionally, or alternatively, the apparatus 1600 may be configured to perform one or more processes described herein, such as process 1300 in FIG. 13, or other processes described herein. In some aspects, the apparatus 1600 and/or one or more components shown in FIG. 16 may include one or more components of the network node described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the network node described above in connection with FIG. 1, such as a radio, one or more RF chains, one or more transceivers, or one or more modems, each of which may in turn be coupled with one or more antennas of the network node. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1604 may be co-located with the reception component 1602.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The transmission component 1604 may transmit, to a UE, first DCI comprising a first indication for the UE to skip a first measurement gap corresponding to a next measurement gap occurrence. The transmission component 1604 may transmit, based at least in part on determining that a next DRX active state of the UE overlaps in time with a second measurement gap that occurs after the next measurement gap occurrence, a signal without data or a signal with dummy data to the UE via a PDSCH. The transmission component 1604 may transmit, to the UE after a beginning of the first measurement gap, second DCI comprising a second indication for the UE to skip the second measurement gap, wherein the second measurement gap corresponds to the next measurement gap occurrence.

The communication manager 1606 may refrain from monitoring for a HARQ transmission from the UE that is associated with the scheduling DCI, based at least in part on the scheduling DCI not comprising the PDSCH scheduling information or the PUSCH grant information.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a UE, comprising: receiving DCI comprising a first indication of whether the UE is to skip a first measurement gap and a second indication of whether the UE is to skip a second measurement gap; selectively skipping the first measurement gap based at least in part on the first indication in the DCI; and selectively skipping the second measurement gap based at least in part on the second indication in the DCI.

Aspect 2: The method of Aspect 1, further comprising: receiving signaling configuring a quantity of indications within the DCI that indicate whether the UE is to skip measurement gaps, wherein receiving the DCI is based at least in part on receiving the signaling.

Aspect 3: The method of Aspect 2, wherein the configured quantity of indications within the DCI is one or more.

Aspect 4: The method of Aspect 2, wherein the signaling comprises RRC signaling.

Aspect 5: The method of any of Aspects 1-4, wherein: the DCI comprises a first bit corresponding to the first indication; and the DCI comprises a second bit corresponding to the second indication.

Aspect 6: The method of any of Aspects 1-5, wherein the DCI is scheduling DCI that does not comprise PDSCH scheduling information or PUSCH grant information.

Aspect 7: The method of Aspect 5, wherein the scheduling DCI comprises: a first field configured to carry scheduling information, the first field comprising an invalid value indicative of the scheduling DCI not comprising the PDSCH scheduling information or the PUSCH grant information; a second field configured to carry scheduling information, the second field comprising a predefined value indicative of the scheduling DCI not comprising the PDSCH scheduling information or the PUSCH grant information; or a third field configured to carry an indication of whether the scheduling DCI comprises the PDSCH scheduling information or the PUSCH grant information, the third field comprising a value indicative of the scheduling DCI not comprising the PDSCH scheduling information or the PUSCH grant information.

Aspect 8: The method of Aspect 5, further comprising: refraining from transmitting a HARQ transmission associated with the scheduling DCI, based at least in part on the scheduling DCI not comprising the PDSCH scheduling information or the PUSCH grant information.

Aspect 9: The method of Aspect 5, further comprising: refraining from restarting a DRX timer responsive to receiving the scheduling DCI, based at least in part on the scheduling DCI not comprising the PDSCH scheduling information or the PUSCH grant information.

Aspect 10: The method of any of Aspects 1-9, wherein: selectively skipping the first measurement gap comprises: skipping the first measurement gap in response to the first indication indicating for the UE to skip the first measurement gap, or measuring a neighbor cell signal strength during the first measurement gap in response to the first indication indicating for the UE to not skip the first measurement gap; and selectively skipping the second measurement gap comprises: skipping the second measurement gap in response to the second indication indicating for the UE to skip the second measurement gap, or measuring the neighbor cell signal strength during the second measurement gap in response to the second indication indicating for the UE to not skip the second measurement gap.

Aspect 11: The method of any of Aspects 1-10, wherein the first measurement gap and the second measurement gap correspond to a next two scheduled occurrences of measurement gaps.

Aspect 12: A method of wireless communication performed by a UE, comprising: receiving signaling indicating a pattern of valid measurement gap occurrences and skipped measurement gap occurrences; measuring a neighbor cell signal strength during the valid measurement gap occurrences indicated by the pattern; and skipping measurement gaps that correspond to the skipped measurement gap occurrences indicated by the pattern.

Aspect 13: The method of Aspect 12, wherein the signaling comprises a bitmap that indicates the pattern of the valid measurement gap occurrences and the skipped measurement gap occurrences.

Aspect 14: The method of Aspect 12, further comprising: receiving DCI comprising an indication that the UE is to skip a next measurement gap occurrence, wherein the pattern indicates that the next measurement gap occurrence is a valid measurement gap occurrence; and skipping a measurement gap that corresponds to the next measurement gap occurrence in response to the DCI comprising the indication.

Aspect 15: The method of Aspect 14, wherein the DCI is scheduling DCI that does not comprise PDSCH scheduling information or PUSCH grant information.

Aspect 16: The method of Aspect 15, wherein the scheduling DCI comprises: a first field configured to carry scheduling information, the first field comprising an invalid value indicative of the scheduling DCI not comprising the PDSCH scheduling information or the PUSCH grant information; a second field configured to carry scheduling information, the second field comprising a predefined value indicative of the scheduling DCI not comprising the PDSCH scheduling information or the PUSCH grant information; or a third field configured to carry an indication of whether the scheduling DCI comprises the PDSCH scheduling information or the PUSCH grant information, the third field comprising a value indicative of the scheduling DCI not comprising the PDSCH scheduling information or the PUSCH grant information.

Aspect 17: The method of Aspect 15, further comprising: refraining from transmitting a HARQ transmission associated with the scheduling DCI, based at least in part on the scheduling DCI not comprising the PDSCH scheduling information or the PUSCH grant information.

Aspect 18: The method of Aspect 15, further comprising: refraining from restarting a DRX timer responsive to receiving the scheduling DCI, based at least in part on the scheduling DCI not comprising the PDSCH scheduling information or the PUSCH grant information.

Aspect 19: The method of Aspect 12, wherein: the valid measurement gap occurrences at least partially overlap in a time domain with a DRX active duration of the UE; and the skipped measurement gap occurrences at least partially overlap in the time domain with a DRX inactive state of the UE.

Aspect 20: The method of Aspect 12, wherein the pattern indicates a periodic pattern of the valid measurement gap occurrences and the skipped measurement gap occurrences.

Aspect 21: The method of Aspect 20, wherein a periodicity of the periodic pattern is based at least in part on a periodicity of a DRX cycle of the UE and a periodicity of measurement gap occurrences.

Aspect 22: The method of Aspect 12, wherein the signaling indicating the pattern comprises RRC signaling or a MAC-CE.

Aspect 23: A method of wireless communication performed by a UE, comprising: receiving signaling indicating for the UE to skip measurement gaps that overlap in a time domain with a DRX active duration of the UE; identifying one or more measurement gaps that overlap in the time domain with the DRX active duration of the UE; and skipping the one or more measurement gaps based at least in part on the one or more measurement gaps overlapping in the time domain with the DRX active duration of the UE.

Aspect 24: The method of Aspect 23, wherein: the signaling indicates a measurement gap configuration for the UE; and the measurement gap configuration indicates for the UE to skip the measurement gaps associated with the measurement gap configuration that overlap in the time domain with the DRX active duration of the UE.

Aspect 25: The method of Aspect 23, wherein the signaling comprises RRC signaling.

Aspect 26: The method of Aspect 23, wherein identifying the one or more measurement gaps comprises: identifying the one or more measurement gaps that overlap with the DRX active duration of the UE for at least a threshold amount of time.

Aspect 27: The method of Aspect 26, further comprising: receiving control information configuring the threshold amount of time, wherein the identifying is based at least in part on receiving the control information.

Aspect 28: The method of Aspect 26, wherein the threshold amount of time corresponds to a duration of one measurement gap.

Aspect 29: A method of wireless communication performed by a UE, comprising: receiving DCI comprising an indication of whether the UE is to skip a measurement gap corresponding to a next measurement gap occurrence that overlaps in time with a DRX active duration of the UE; switching from a DRX active state to a DRX inactive state for a DRX inactive duration, wherein the DRX inactive duration of the UE overlaps in time with one or more measurement gaps; switching from the DRX inactive state to the DRX active state after the DRX inactive duration; and selectively skipping the measurement gap based at least in part on the measurement gap corresponding to the next measurement gap occurrence that overlaps in time with the DRX active duration of the UE.

Aspect 30: The method of Aspect 29, wherein the next measurement gap occurrence that overlaps in time with the DRX active duration of the UE occurs after the DCI is received and after the one or more measurement gaps that overlap in time with the DRX inactive duration of the UE.

Aspect 31: The method of Aspect 29, wherein the DCI is scheduling DCI that does not comprise PDSCH scheduling information or PUSCH grant information.

Aspect 32: The method of Aspect 31, wherein the scheduling DCI comprises: a first field configured to carry scheduling information, the first field comprising an invalid entry indicative of the scheduling DCI not comprising the PDSCH scheduling information or the PUSCH grant information; a second field configured to carry scheduling information, the second field comprising a predefined value indicative of the scheduling DCI not comprising the PDSCH scheduling information or the PUSCH grant information; or a third field configured to carry an indication of whether the scheduling DCI comprises the PDSCH scheduling information or the PUSCH grant information, the third field comprising a value indicative of the scheduling DCI not comprising the PDSCH scheduling information or the PUSCH grant information.

Aspect 33: The method of Aspect 31, further comprising: refraining from transmitting a HARQ transmission associated with the scheduling DCI, based at least in part on the scheduling DCI not comprising the PDSCH scheduling information or the PUSCH grant information.

Aspect 34: The method of Aspect 31, further comprising: refraining from restarting a DRX timer responsive to receiving the scheduling DCI, based at least in part on the scheduling DCI not comprising the PDSCH scheduling information or the PUSCH grant information.

Aspect 35: The method of Aspect 29, wherein the DCI comprises a single bit corresponding to the indication.

Aspect 36: The method of Aspect 29, wherein selectively skipping the measurement gap comprises: skipping the measurement gap in response to the indication indicating for the UE to skip the measurement gap; or measuring a neighbor cell signal strength during the measurement gap in response to the indication indicating for the UE to not skip the measurement gap.

Aspect 37: A method of wireless communication performed by a UE, comprising: measuring, during a DRX active duration of the UE, a neighbor cell signal strength during a measurement gap; adjusting one or more parameters associated with a DRX cycle of the UE based at least in part on an overlap in time between the DRX active duration of the UE and the measurement gap; and extending the DRX active duration of the UE for the DRX cycle in accordance with the adjusting.

Aspect 38: The method of Aspect 37, further comprising: switching from a DRX active state of the UE to a DRX inactive state of the UE after the measurement gap; and switching from the DRX inactive state to the DRX active state during the DRX cycle based at least in part on the adjusting, wherein extending the DRX active duration of the UE is based at least in part on switching to the DRX active state.

Aspect 39: The method of Aspect 37, further comprising: refraining from switching from a DRX active state of the UE to a DRX inactive state of the UE after the measurement gap, based at least in part on the adjusting, wherein extending the DRX active duration of the UE is based at least in part on the refraining.

Aspect 40: The method of Aspect 37, wherein adjusting the one or more parameters comprises adjusting a DRX inactive timer or adjusting a DRX on duration timer.

Aspect 41: A method of wireless communication performed by a network node, comprising: transmitting, to a UE, first DCI comprising a first indication for the UE to skip a first measurement gap corresponding to a next measurement gap occurrence; transmitting, based at least in part on determining that a next DRX active state of the UE overlaps in time with a second measurement gap that occurs after the next measurement gap occurrence, a signal without data or a signal with dummy data to the UE via a PDSCH; and transmitting, to the UE after a beginning of the first measurement gap, second DCI comprising a second indication for the UE to skip the second measurement gap, wherein the second measurement gap corresponds to the next measurement gap occurrence.

Aspect 42: The method of Aspect 41, wherein transmitting the signal without the data or the signal with dummy data is further based at least in part on determining that a current DRX active duration of the UE ends prior to the beginning of the first measurement gap absent any transmissions from the network node to the UE.

Aspect 43: The method of any of Aspects 41-42, wherein the first DCI or the second DCI is scheduling DCI that does not comprise PDSCH scheduling information or PUSCH grant information.

Aspect 44: The method of Aspect 43, wherein the scheduling DCI comprises: a first field configured to carry scheduling information, the first field comprising an invalid value indicative of the scheduling DCI not comprising the PDSCH scheduling information or the PUSCH grant information; a second field configured to carry scheduling information, the second field comprising a predefined value indicative of the scheduling DCI not comprising the PDSCH scheduling information or the PUSCH grant information; or a third field configured to carry an indication of whether the scheduling DCI comprises the PDSCH scheduling information or the PUSCH grant information, the third field comprising a value indicative of the scheduling DCI not comprising the PDSCH scheduling information or the PUSCH grant information.

Aspect 45: The method of Aspect 43, further comprising: refraining from monitoring for a HARQ transmission from the UE that is associated with the scheduling DCI, based at least in part on the scheduling DCI not comprising the PDSCH scheduling information or the PUSCH grant information.

Aspect 46: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-45.

Aspect 47: An apparatus for wireless communication at a device, the apparatus comprising one or more memories and one or more processors coupled to the one or more memories, the one or more processors configured to cause the device to perform the method of one or more of Aspects 1-45.

Aspect 48: An apparatus for wireless communication, the apparatus comprising at least one means for performing the method of one or more of Aspects 1-45.

Aspect 49: A non-transitory computer-readable medium storing code for wireless communication, the code comprising instructions executable by one or more processors to perform the method of one or more of Aspects 1-45.

Aspect 50: A non-transitory computer-readable medium storing a set of instructions for wireless communication, the set of instructions comprising one or more instructions that, when executed by one or more processors of a device, cause the device to perform the method of one or more of Aspects 1-45.

Aspect 51: A device for wireless communication, the device comprising a processing system that includes one or more processors and one or more memories coupled with the one or more processors, the processing system configured to cause the device to perform the method of one or more of Aspects 1-45.

Aspect 52: An apparatus for wireless communication at a device, the apparatus comprising one or more memories and one or more processors coupled to the one or more memories, the one or more processors individually or collectively configured to cause the device to perform the method of one or more of Aspects 1-45.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive downlink control information comprising a first indication of whether the UE is to skip a first measurement gap and a second indication of whether the UE is to skip a second measurement gap;
selectively skip the first measurement gap based at least in part on the first indication in the downlink control information; and
selectively skip the second measurement gap based at least in part on the second indication in the downlink control information.

2. The UE of claim 1, wherein the processing system is configured to cause the UE to:
receive signaling configuring a quantity of indications within the downlink control information that indicate whether the UE is to skip measurement gaps, wherein the processing system is configured to cause the UE to receive the downlink control information based at least in part on receiving the signaling.

3. The UE of claim 2, wherein the configured quantity of indications within the downlink control information is one or more.

4. The UE of claim 2, wherein the signaling comprises radio resource control signaling.

5. The UE of claim 1, wherein:
the downlink control information comprises a first bit corresponding to the first indication; and
the downlink control information comprises a second bit corresponding to the second indication.

6. The UE of claim 1, wherein the downlink control information is scheduling downlink control information that does not comprise physical downlink shared channel scheduling information or physical uplink shared channel grant information.

7. The UE of claim 6, wherein the scheduling downlink control information comprises:
a first field configured to carry scheduling information, the first field comprising an invalid value indicative of the scheduling downlink control information not comprising the physical downlink shared channel scheduling information or the physical uplink shared channel grant information;
a second field configured to carry scheduling information, the second field comprising a predefined value indicative of the scheduling downlink control information not comprising the physical downlink shared channel scheduling information or the physical uplink shared channel grant information; or
a third field configured to carry an indication of whether the scheduling downlink control information comprises the physical downlink shared channel scheduling information or the physical uplink shared channel grant information, the third field comprising a value indicative of the scheduling downlink control information not comprising the physical downlink shared channel scheduling information or the physical uplink shared channel grant information.

8. The UE of claim 6, wherein the processing system is configured to cause the UE to:
refrain from transmitting a hybrid automatic repeat request (HARQ) transmission associated with the scheduling downlink control information, based at least in part on the scheduling downlink control information not comprising the physical downlink shared channel scheduling information or the physical uplink shared channel grant information.

9. The UE of claim 6, wherein the processing system is configured to cause the UE to:
refrain from restarting a discontinuous reception timer responsive to receiving the scheduling downlink control information, based at least in part on the scheduling downlink control information not comprising the physical downlink shared channel scheduling information or the physical uplink shared channel grant information.

10. The UE of claim 1, wherein:
to selectively skip the first measurement gap, the processing system is configured to cause the UE to:
skip the first measurement gap in response to the first indication indicating for the UE to skip the first measurement gap, or
measure a neighbor cell signal strength during the first measurement gap in response to the first indication indicating for the UE to not skip the first measurement gap; and
to selectively skip the second measurement gap, the processing system is configured to cause the UE to:
skip the second measurement gap in response to the second indication indicating for the UE to skip the second measurement gap, or
measure the neighbor cell signal strength during the second measurement gap in response to the second indication indicating for the UE to not skip the second measurement gap.

11. The UE of claim 1, wherein the first measurement gap and the second measurement gap correspond to a next two scheduled occurrences of measurement gaps.

12. A method of wireless communication performed by a user equipment (UE), comprising:
receiving downlink control information comprising a first indication of whether the UE is to skip a first measurement gap and a second indication of whether the UE is to skip a second measurement gap;
selectively skipping the first measurement gap based at least in part on the first indication in the downlink control information; and
selectively skipping the second measurement gap based at least in part on the second indication in the downlink control information.

13. The method of claim 12, further comprising:
receiving signaling configuring a quantity of indications within the downlink control information that indicate whether the UE is to skip measurement gaps, wherein receiving the downlink control information is based at least in part on receiving the signaling.

14. The method of claim 13, wherein the configured quantity of indications within the downlink control information is one or more.

15. The method of claim 13, wherein the signaling comprises radio resource control signaling.

16. The method of claim 12, wherein:
the downlink control information comprises a first bit corresponding to the first indication; and
the downlink control information comprises a second bit corresponding to the second indication.

17. The method of claim 12, wherein the downlink control information is scheduling downlink control information that does not comprise physical downlink shared channel scheduling information or physical uplink shared channel grant information.

18. The method of claim 17, wherein the scheduling downlink control information comprises:
a first field configured to carry scheduling information, the first field comprising an invalid value indicative of the scheduling downlink control information not comprising the physical downlink shared channel scheduling information or the physical uplink shared channel grant information;
a second field configured to carry scheduling information, the second field comprising a predefined value indicative of the scheduling downlink control information not comprising the physical downlink shared channel scheduling information or the physical uplink shared channel grant information; or
a third field configured to carry an indication of whether the scheduling downlink control information comprises the physical downlink shared channel scheduling information or the physical uplink shared channel grant information, the third field comprising a value indicative of the scheduling downlink control information not comprising the physical downlink shared channel scheduling information or the physical uplink shared channel grant information.

19. The method of claim 17, further comprising:
refraining from transmitting a hybrid automatic repeat request (HARQ) transmission associated with the scheduling downlink control information, based at least in part on the scheduling downlink control information not comprising the physical downlink shared channel scheduling information or the physical uplink shared channel grant information.

20. A non-transitory computer-readable medium storing a set of instructions for wireless communication, the set of instructions comprising:
one or more instructions that, when executed by one or more processors of a user equipment (UE), cause the UE to:
receive downlink control information comprising a first indication of whether the UE is to skip a first measurement gap and a second indication of whether the UE is to skip a second measurement gap;
selectively skip the first measurement gap based at least in part on the first indication in the downlink control information; and
selectively skip the second measurement gap based at least in part on the second indication in the downlink control information.
